(19) United States
(12) Patent Application Publication
(10) Pub. No.: US 2006/0278218 A1
(43) Pub. Date: Dec. 14, 2006

(54) Non-invasive restrained whole body plethysmography for measurement of airway function in conscious mice

(76) Inventor: Andrew M. Hoffman, Sutton, MA (US)

Correspondence Address: MILLS & ONELLO LLP, ELEVEN BEACON STREET, SUITE 605, BOSTON, MA, 02108, US

(21) Appl. No.: 11/436,287

(22) Filed: May 18, 2006

Related U.S. Application Data
(60) Provisional application No. 60/683,245, filed on May 20, 2005.
(60) Provisional application No. 60/727,104, filed on Oct. 14, 2005.

(51) Int. Cl. A62B 7/00; A62B 9/00

(52) U.S. Cl. 128/200.24

(57) ABSTRACT

A restrained whole body plethysmography apparatus for measurement of airway hyper-responsiveness in conscious mice includes an outer chamber, a removable restraint chamber positioned in the outer chamber, a removable docking station in the outer chamber. The removable restraint chamber and the removable docking station interconnect to restrain a mouse in the outer chamber. The restrained whole body plethysmography further includes a first sensor for measuring a first parameter related to respiratory function in the mouse and a second sensor for measuring a second parameter related to respiratory function in the mouse. In a first mode, the outer chamber is substantially sealed such that the apparatus measures pressure, and in a second mode, the outer chamber has a leak such that the apparatus is used to measure flow.

### RELATED APPLICATIONS

This application claims the benefit of U.S. Provisional Application Ser. No. 60/683,245, filed May 20, 2005, and U.S. Provisional Application Ser. No. 60/727,104, filed Oct. 14, 2005, the contents of each being incorporated herein by reference, in their entirety.

### BACKGROUND OF THE INVENTION

The mouse is the most extensively studied species in respiratory research, yet the technologies available to assess airway function in conscious mice are not universally accepted. The use of mice in respiratory research is growing, in part due to the rapid development of new transgenic strains. These new mouse strains require extensive characterization of their biology and pathology. A major application of transgenic animal models is the study of asthma biology, therefore necessitating the characterization of airway dimensions in vivo. Precise measurements of airway function may be obtained using invasive technologies that control for the confounding influences of lung volume (i.e. volume history, lung volume during measurement) and respiratory frequency (Bates, J. H. and C. G. Irvin (2003). “Measuring lung function in mice: the phenotyping uncertainty principle.” J Appl Physiol 94(4): 1297-306. (hereinafter Bates, et al.) incorporated herein by reference) However, an important place remains for the in vivo study of conscious mice, where the influences and risks of anesthesia are absent, and conscious factors that potentially modulate the effects of agonists are present. Currently, a problem with the study of conscious mice is the lack of widely accepted techniques. The available methods each have advantages and disadvantages that relate to: (1) ease of the procedure, (2) animal tolerance, (3) precision and validation, and (4) their basis in known physical determinants of airway function (i.e., pressure and flow). Recently, concern has been expressed over the widespread use of unrestrained technology to characterize ‘airway function’ per se Mitzner, W. and C. Tankersley (1998). “Noninvasive measurement of airway responsiveness in allergic mice using barometric plethysmography.” Am J Respir Crit Care Med 158(1): 340-1., incorporated herein by reference, Hantos, Z. and V. Brusasco (2002). “Assessment of respiratory mechanics in small animals: the simpler the better?” J Appl Physiol 93(4): 1196-7., incorporated herein by reference, Bates, et al., and Sly, P. D., D. J. Turner, et al. (2005). “Penh is not a validated technique for measuring airway function in mice.” Am J Respir Crit Care Med 172(2): 256., incorporated herein by reference). These opinions were formed after several studies failed to corroborate data derived from unsrestrained whole body plethysmography (UWBP) with more rigorous invasive techniques Petak, F., W. Habre, et al. (2001). “Hyperoxia-induced changes in mouse lung mechanics: forced oscillations vs. barometric plethysmography.” J Appl Physiol 90(6): 2221-30., incorporated herein by reference, Lundblad, L. K., C. G. Irvin, et al. (2002). “A reevaluation of the validity of unrestrained plethysmography in mice.” J Appl Physiol 93(4): 1198-207. (hereinafter Lundblad, et al.), incorporated herein by reference, Adler, A., G. Cieslewicz, et al. (2004). “Unrestrained plethysmography is an unreliable measure of airway responsiveness in BALB/c and C57BL/6 mice.” J Appl Physiol 97(1): 286-92., incorporated herein by reference, and Schwarze, J., E. Hamelmann, et al. (2005). “Barometric whole body plethysmography in mice.” J Appl Physiol 98(5): 1955-7., incorporated herein by reference). Since UWBP is a commonplace application, this has left many users searching for practical alternatives (Kips, J. C., G. P. Anderson, et al. (2003). “Murine models of asthma.” Eur Respir J 22(2): 374-82, incorporated herein by reference). Several alternative methods have been studied which do provide more direct measures of airway mechanics. Mid-tidal expiratory flow (EF50) has been evaluated extensively for the ability to characterize bronchoconstriction in conscious mice (Vijayaraghavan, R., M. Schaper, et al. (1993). “Characteristic modifications of the breathing pattern of mice to evaluate the effects of airborne chemicals on the respiratory tract.” Arch Toxicol 67(7): 478-90., incorporated herein by reference, Glaab, T., A. Daser, et al. (2001). “Tidal midexpiratory flow as a measure of airway hyperresponsiveness in allergic mice.” Am J Physiol Lung Cell Mol Physiol 280(3): L565-73. (hereinafter Glaab, Daser, et al.), incorporated herein by reference, Glaab, T., H. G. Hoymann, et al. (2002). “Noninvasive measurement of midexpiratory flow indicates bronchoconstriction in allergic rats.” J Appl Physiol 93(4): 1208-14., incorporated herein by reference, Glaab, T., M. Ziegert, et al. (2005). “Invasive versus noninvasive measurement of allergic and cholinergic airway responsiveness in mice.” Respir Res 6: 139. (hereinafter Glaab, Ziegert, et al.), incorporated herein by reference). Outcomes of EF50 have correlated well with simultaneous invasive measures of pulmonary resistance and dynamic compliance during allergen, cholinergic agonist, and hyperoxia challenges (Glaab, Daser, et al., Glaab, Ziegert, et al., and Glaab, T., W. Mitzner, et al. (2004). “Repetitive measurements of pulmonary mechanics to inhaled cholinergic challenge in spontaneously breathing mice.” J Appl Physiol 97(3): 1104-11., incorporated herein by reference). While EF50 permits the monitoring of tidal breathing flow limitation, one can only infer airway resistance from plethysmographically derived flow. The use of a neck seal to restrain mice for EF50 may pose additional problems. Specific airway resistance (sRaw), the product of airway resistance (Raw) and lung volume, could provide greater insight into airway mechanics (Flandre, T. D., P. L. Leroy, et al. (2003). “Effect of somatic growth, strain, and sex on double-chamber plethysmographic respiratory function values in healthy mice.” J Appl Physiol 94(3): 1129-36. (hereinafter Flandre, et al.), incorporated herein by reference, and, P., D. B. Anh, et al. (2005). “Sendai virus-induced alterations in lung structure/function correlate with viral loads and reveal a wide resistance/susceptibility spectrum among mouse strains.” Am J Physiol Lung Cell Mol Physiol 289(5): L777-87. (hereinafter Faisca, et al.), incorporated herein by reference). This variable can be measured using double chamber plethysmography (Pennock, B. E., C. P. Cox, et al. (1979). “A noninvasive technique for measurement of changes in specific airway resistance.” J Appl Physiol 46(2): 399-406. (hereinafter Pennock, et al.), incorporated herein by reference), although there are practical limitations such as the use a neck seal and complex restrainer (Flandre, et al.). The reproducibility of airway reactivity derived from double chamber plethysmography (DCP) has also been challenged (DeLorme, M. P. and O. R. Moss (2002). “Pulmonary function assessment by whole-body plethysmography in restrained versus unrestrained mice.” J Pharmacol Toxicol Methods 47(1): 1-10. (hereinafter Delorme, et al.), incorporated herein by reference), and strain-specific responses to methacholine were discordant with more invasive methods (Duguet, A., K. Biyah, et al. (2000). “Bronchial responsiveness among inbred mouse strains. Role of airway smooth-muscle shortening velocity.” Am J Respir Crit Care Med 161(3 Pt 1): 839-48. (hereinafter Duguet, et al.), incorporated herein by reference). For these reasons, the current method to measure sRaw using DCP is not widely cited. Transfer impedance is yet another conscious method, which is used to probe central (airway) vs. peripheral (tissue) contributions to bronchoconstriction (Hessel, E. M., A. Zwart, et al. (1995). “Repeated measurement of respiratory function and bronchoconstriction in unanesthetized mice.” J Appl Physiol 79(5): 1711-6. (hereinafter Hessel, et al.), incorporated herein by reference). This technique however, required significant acclimation of the mice to the instrument. In sum, each available system provides a different level of user satisfaction and certainty regarding the status of the airways (Bates, et al.), and therefore the development of novel systems that improve upon this spectrum of technologies should continue.

The method of body plethysmography (pressure plethysmography) has been used in humans (DuBois, A., S. Botelho, et al. (1956). “A new method for measuring airway resistance in man using a body plethysmograph: values in normal subjects and in patients with respiratory disease.” J Clin Invest 35: 327-335. (hereinafter DuBois, et al.), incorporated herein by reference) and later used in guinea pigs (Agrawal, K. P. (1981). “Specific airways conductance in guinea pigs: normal values and histamine induced fall.” Respir Physiol 43(1): 23-30. (hereinafter Agrawal K P), incorporated herein by reference). Mice are fast breathers (3-6 Hz) so special considerations concerning plethysmographic design and validation need to be addressed.

### SUMMARY OF THE INVENTION

The present invention is directed to an apparatus for monitoring an apparatus for monitoring respiratory function in an animal. The apparatus includes a restraint chamber for restraining the animal. The restraint chamber includes a nose cone at a first end for receiving the head of the animal and a tube having a plurality of holes at a second end. The nose cone and the tube are coupled such that the restraint chamber is non-constraining. The apparatus includes an outer chamber in which the restraint chamber is positioned. The apparatus includes a first sensor mounted to a proximal end of the nose cone of the restraint chamber for detecting a first parameter related to respiratory function in the animal and a second sensor coupled to the outer chamber for detecting a second parameter related to respiratory function in the animal.

In one embodiment, the tube that has the plurality of holes includes holes overlying a chest and abdomen of the animal.

In one embodiment, the restraint chamber is coupled to the first sensor by a docking station.

In one embodiment, the docking station includes a nose cone receptor for receiving the nose cone of the restraint chamber. In one embodiment, the nose cone receptor and nose cone provide visualization of a seal of the nose. In another embodiment, the docking station includes a rotating stopcock. In another embodiment, the stopcock assembly permits each of nasal flow measurement, aerosol delivery, and leak testing of the nose cone, each from outside the box. In another embodiment, the docking station includes a pneumotachograph.

In one embodiment, the apparatus further includes a platform having a track, and the restraint chamber includes a guide that moves along the track such that the track facilitates the movement of the restraint chamber.

In one embodiment, the first and second parameters are related to resistance of an airway of the animal. In another embodiment, the first parameter is related to air flow at the nose of the animal. In another embodiment, the second parameter is related to a pressure change in the chamber. In another embodiment, the second parameter is related to a pressure change in the animal. In another embodiment, the second parameter is related to volume of the body of the animal. In another embodiment, the first and second parameters are combined to monitor respiratory function in the animal.

In one embodiment, in a first mode, the outer chamber is substantially sealed such that the apparatus measures pressure, and in a second mode, the outer chamber has a leak such that the apparatus is used to measure flow.

In accordance with another aspect of the invention, the invention is directed to an apparatus for monitoring respiratory function in an animal. The apparatus includes a restraint chamber for restraining the animal. The restraint chamber includes a nose cone at a first end for receiving the head of the animal and a tube having a plurality of holes at a second end. The apparatus further includes a docking station for interlocking with the restraint chamber. The docking station includes a first sensor for detecting a first parameter related to respiratory function in the animal. The apparatus includes an outer chamber in which the restraint chamber and the docking station are positioned, and a second sensor coupled to the outer chamber for detecting a second parameter related to respiratory function in the animal.

In one embodiment, the tube that has the plurality of holes includes holes overlying a chest and abdomen of the animal.

In one embodiment, the docking station includes a nose cone receptor for receiving the nose cone of the restraint chamber. In one embodiment, the nose cone receptor and nose cone provide visualization of a seal of the nose. In another embodiment, the docking station includes a rotating stopcock. In another embodiment, the stopcock assembly permits each of nasal flow measurement, aerosol delivery, and leak testing of the nose cone, each from outside the box. In another embodiment, the docking station includes a pneumotachograph.

In one embodiment, the apparatus further includes a platform having a track, and the restraint chamber includes a guide that moves along the track such that the track facilitates the movement of the restraint chamber.

In one embodiment, the first and second parameters are related to resistance of an airway of the animal. In another embodiment, the first parameter is related to air flow at the nose of the animal. In another embodiment, the second parameter is related to a pressure change in the chamber. In another embodiment, the second parameter is related to pressure change in the animal. In another embodiment, the second parameter is related to volume of the body of the animal. In another embodiment, the first and second parameters are combined to monitor respiratory function in the animal.

In one embodiment, in a first mode, the outer chamber is substantially sealed such that the apparatus measures pressure, and in a second mode, the outer chamber has a leak such that the apparatus is used to measure flow.

In accordance with another aspect of the invention, the invention is directed to an apparatus for monitoring respiratory function in an animal. The apparatus includes a restraint chamber for restraining the animal. The restraint chamber includes a nose cone at a first end for receiving the head of the animal and a tube having a plurality of holes at a second end. The tube has a protrusion and the protrusion has a sliding track. The tube slides with respect to the nose cone along the sliding track of the protrusion coupling the tube to the nose cone. The apparatus further includes an outer chamber in which the restraint chamber is positioned. The apparatus includes a first sensor mounted to a proximal end of the nose cone of the restraint chamber for detecting a first parameter related to respiratory function in the animal and a second sensor coupled to the outer chamber for detecting a second parameter related to respiratory function in the animal.

In one embodiment, the tube that has the plurality of holes includes holes overlying a chest and abdomen of the animal.

In one embodiment, the restraint chamber is coupled to the first sensor by a docking station.

In one embodiment, the docking station includes a nose cone receptor for receiving the nose cone of the restraint chamber. In one embodiment, the nose cone receptor and nose cone provide visualization of a seal of the nose. In another embodiment, the docking station includes a rotating stopcock. In another embodiment, the stopcock assembly permits each of nasal flow measurement, aerosol delivery, and leak testing of the nose cone, each from outside the box. In another embodiment, the docking station includes a pneumotachograph.

In one embodiment, the apparatus further includes a platform having a track, and the restraint chamber includes a guide that moves along the track such that the track facilitates the movement of the restraint chamber.

In one embodiment, the first and second parameters are related to resistance of the airways of the animal. In another embodiment, the first parameter is related to air flow at the nose of the animal. In another embodiment, the second parameter is related to a pressure change in the chamber. In another embodiment, the second parameter is related to pressure change in the animal. In another embodiment, the second parameter is related to volume of the body of the animal. In another embodiment, the first and second parameters are combined to monitor respiratory function in the animal.

In one embodiment, in a first mode, the outer chamber is substantially sealed such that the apparatus measures pressure, and in a second mode, the outer chamber has a leak such that the apparatus is used to measure flow.

In accordance with another aspect of the invention, the invention is directed to an apparatus for monitoring respiratory function in an animal. The apparatus includes a restraint chamber for restraining the animal. The restraint chamber includes a nose cone at a first end for receiving the head of the animal and a tube having a plurality of holes and a protrusion having a sliding track at a second end. The nose cone slides with respect to the tube along the sliding track of the protrusion coupling the nose cone to the tube. The apparatus further includes an outer chamber in which the restraint chamber and the platform are positioned. The apparatus includes a first sensor coupled to a proximal end of the nose cone of the restraint chamber for detecting a first parameter related to respiratory function in the animal and a second sensor coupled to the outer chamber for detecting a second parameter related to respiratory function in the animal.

In one embodiment, the tube that has the plurality of holes includes holes overlying a chest and abdomen of the animal.

In one embodiment, the restraint chamber is coupled to the first sensor by a docking station.

In one embodiment, the docking station includes a nose cone receptor for receiving the nose cone of the restraint chamber. In one embodiment, the nose cone receptor and nose cone provide visualization of a seal of the nose. In another embodiment, the docking station comprises a rotating stopcock. In another embodiment, the stopcock assembly permits each of nasal flow measurement, aerosol delivery, and leak testing of the nose cone, each from outside the box. In another embodiment, the docking station comprises a pneumotachograph.

In one embodiment, the apparatus further includes a platform having a track, and the restraint chamber includes a guide that moves along the track such that the track facilitates the movement of the restraint chamber.

In one embodiment, the first and second parameters are related to resistance of an airway of the animal. In another embodiment, the first parameter is related to air flow at the nose of the animal. In another embodiment, the second parameter is related to a pressure change in the chamber. In another embodiment, the second parameter is related to pressure change in the animal. In another embodiment, the second parameter is related to volume of the body of the animal. In another embodiment, the first and second parameters are combined to monitor respiratory function in the animal.

In one embodiment, in a first mode, the outer chamber is substantially sealed such that the apparatus measures pressure, and in a second mode, the outer chamber has a leak such that the apparatus is used to measure flow.

In accordance with another aspect of the invention, the invention is directed to an apparatus for monitoring respiratory function in an animal. The apparatus includes a restraint chamber for restraining the animal and an outer chamber in which the restraint chamber is positioned. In a first mode, the outer chamber is substantially sealed such that the apparatus measures pressure, and in a second mode, the outer chamber has a leak such that the apparatus is used to measure flow.

In one embodiment, the restraint chamber comprises a nose cone at a first end for receiving the head of the animal and a tube having a plurality of holes at a second end. In another embodiment, the tube having the plurality of holes includes holes overlying a chest and abdomen of the animal.

In another embodiment, the apparatus further includes a first sensor mounted to a proximal end of the nose cone of the restraint chamber for detecting a first parameter related to respiratory function in the animal. In another embodiment, the apparatus further comprises a second sensor coupled to the outer chamber for detecting a second parameter related to respiratory function in the animal.

In another embodiment, the restraint chamber is coupled to the first sensor by a docking station. In another embodiment, the docking station includes a nose cone receptor for receiving the nose cone of the restraint chamber. In another embodiment, the nose cone receptor and nose cone provide visualization of a seal of the nose.

In another embodiment, the docking station comprises a rotating stopcock. In another embodiment, the stopcock assembly permits each of nasal flow measurement, aerosol delivery, and leak testing of the nose cone, each from the outside of the box.

In another embodiment, the docking station comprises a pneumotachograph.

In one embodiment, the apparatus further includes a platform having a track, and the restraint chamber further comprises a guide that moves along the track such that the track facilitates the movement of the restraint chamber.

In one embodiment, the first and second parameters are related to resistance of an airway of the animal. In another embodiment, the first parameter is related to air flow at the nose of the animal. In another embodiment, the second parameter is related to a pressure change in the chamber. In another embodiment, the second parameter is related to a pressure change in the animal. In another embodiment, the second parameter is related to volume of the body of the animal. In another embodiment, the first and second parameters are combined to monitor respiratory function in the animal.

### BRIEF DESCRIPTION OF THE DRAWINGS

FIG. 1 is a perspective view a restrained whole body plethysmography (RWBP) according to an embodiment of the present invention.

FIG. 2 is a perspective view of an embodiment of the outer chamber of the RWBP of FIG. 1.

FIG. 3 is a perspective view of an embodiment of the restraint chamber of FIG. 1.

FIG. 4 is a perspective view of an embodiment of the restraint chamber of FIG. 3 in an open position.

FIG. 5 is a perspective view of an alternative embodiment of the restraint chamber of FIG. 3.

FIG. 6 is a perspective view of an embodiment of the docking station of FIG. 1.

FIGS. 7A, 7B and 7C are perspective views of positions of an embodiment of an aerosol tube of FIG. 6.

FIG. 8 is a perspective view of an embodiment of the restraint chamber of FIG. 3 and the docking station of FIG. 6 connected with the outer chamber of FIG. 2.

FIGS. 9A, 9B, 9C and 9D are strip charts for pneumotachograph flow and plethysmographic volume and box volume-flow plots of experiments performed with an RWBP according to an embodiment of the invention

FIGS. 10A, 10B and 10C are dose response curves of experiments performed with an RWBP according to an embodiment of the invention.

FIG. 11 is a dose response curve of experiments performed with a forced oscillation technique (FOT).

FIG. 12 is a comparison of methacholine responses between methods.

### DETAILED DESCRIPTION OF PREFERRED EMBODIMENTS

To address this gap in technology at a time when there is increasing interest in the use of mice, the present invention provides a technique of restrained whole body plethysmography (RWBP) that is modified from whole body plethysmography, for a precise, non-invasive measurement of specific airway resistance (sRaw). According to the invention, conscious unsedated mice are restrained in a porous tube with a pneumotachograph attached for collection of flow. The porous chamber is positioned within a larger plethysmographic chamber for recording of box pressure, and the pressure-flow signals are analyzed to produce sRaw. Mice readily accept restraint in the holding tubes due to their extremely poor eyesight and thigmotropy, i.e., attraction to walls and surfaces. The sRaw measured using RWBP is reproducible between typical experimental periods (within hour, within day, between day), the absolute values for sRaw are accurate when compared to FOT, and the methacholine responses in two mouse strains with known phenotypic differences can be differentiated with equal fidelity using RWBP or FOT.

The intent of the experimentation was to provide an initial proof of concept for RWBP in conscious mice and thus stimulate future applications and comparisons with alternative systems. Thru the study, it was hypothesized that 1) values for sRaw measured with RWBP (sRaw-RWBP) would be comparable to sRaw derived using airway resistance from the forced oscillation technique (Raw-FOT) and by conscious double chamber plethymsography (sRaw-DCP), 2) baseline sRaw-RWBP and associated methacholine responses would be similarly reproducible to Raw-FOT, 3) RWBP and FOT would similarly characterize the relative degree of airway reactivity for three strains of mice (C57BL/6, A/J, and BALBc), 4) maximal (i.e. plateau) responses to methacholine would be the same for sRaw-RWBP, sRaw-DPC, and Raw-FOT, and lastly, that 5) RWBP would appropriately characterize the shift in airway reactivity associated with allergen challenge in BALBc mice.

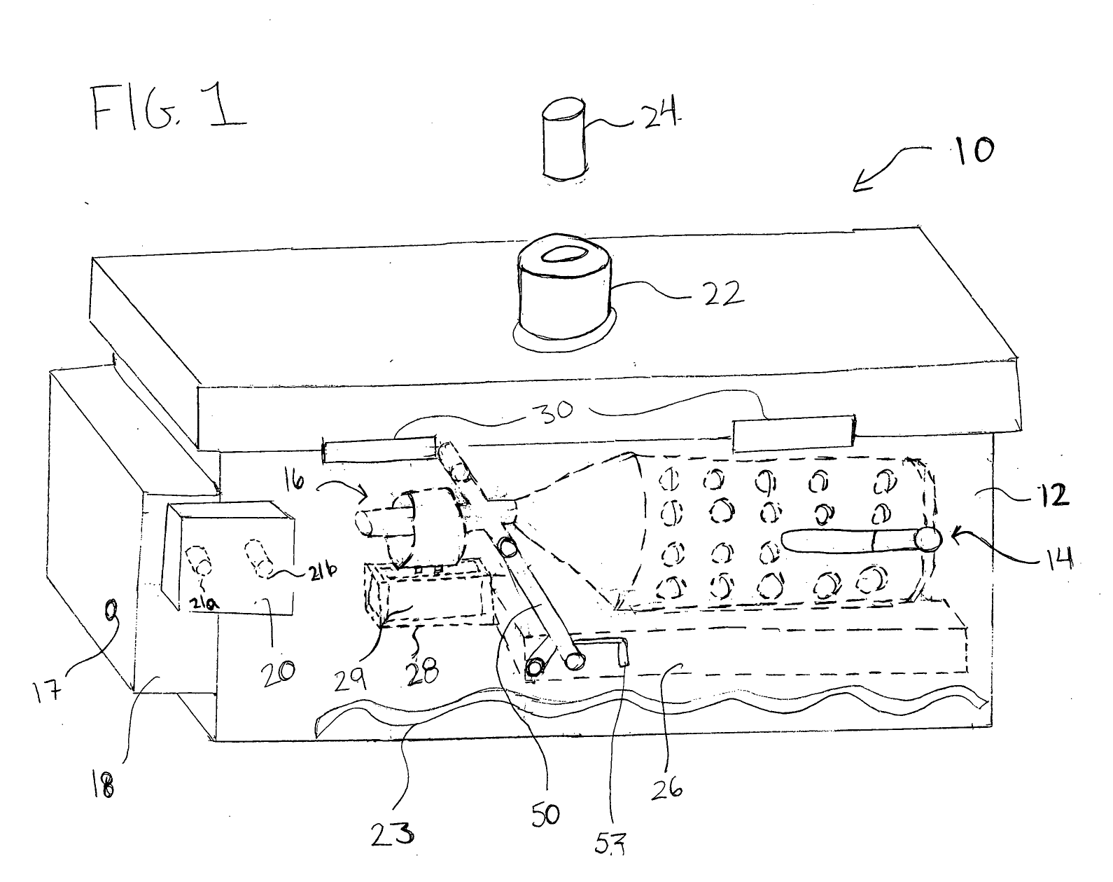

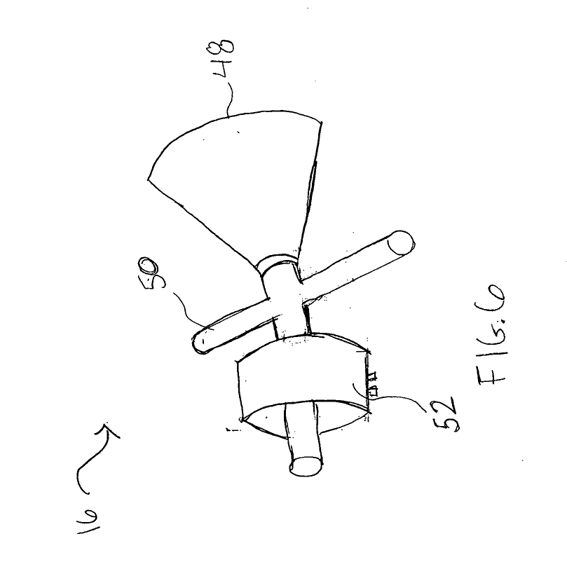

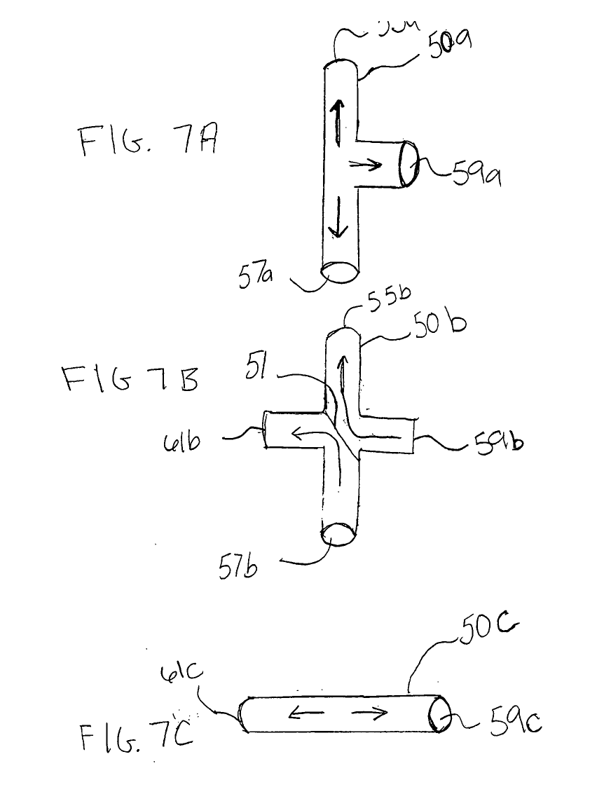

FIG. 1 is a perspective view of an embodiment of the RWBP according to the present invention. The RWBP 10 includes an outer chamber 12 that accommodates a single mouse within a porous restraint chamber 14. The RWBP 10 includes the outer chamber 12, the restraint chamber 14, a docking station 16, a reference chamber 18 having a leak 17, a pressure transducer 20, an opening 22, a plug 24 for selectively and controllably sealing the opening 22, a stationary platform 26 for the restraint chamber 14 and the docking station 16, a flow transducer housing 28, and clamps 30 for sealing the top portion of the outer chamber 12 to the bottom portion of the outer chamber 12. The restraint chamber 14 and the docking station 16 are both removable from the outer chamber. An aerosol tube 50 extends through the box to the outside, the aerosol tube having a handle 53 for rotating the aerosol tube 50 into different positions, as described below in connection with FIGS. 7A, 7B and 7C. The aerosol tube protruding from the outer chamber 12 at the far end of the tube is an exhaust, while the aerosol tube protruding from the outer chamber 12 at the front end is for aerosol or injection. The aerosol tube extending from the box at the front end has a two piece opening, one being an aerosol port and the other being and injection port. The tubes extending from the box allow aerosol or an injection to be supplied to the apparatus from the outside such that the outer box does not need to be opened, such that temperature equilibration is maintained during testing. The aerosol tube 50 is further connected to the nose cone and extends through a pneumotachograph 52 of the docking station 16 and is open to the inside of the box.

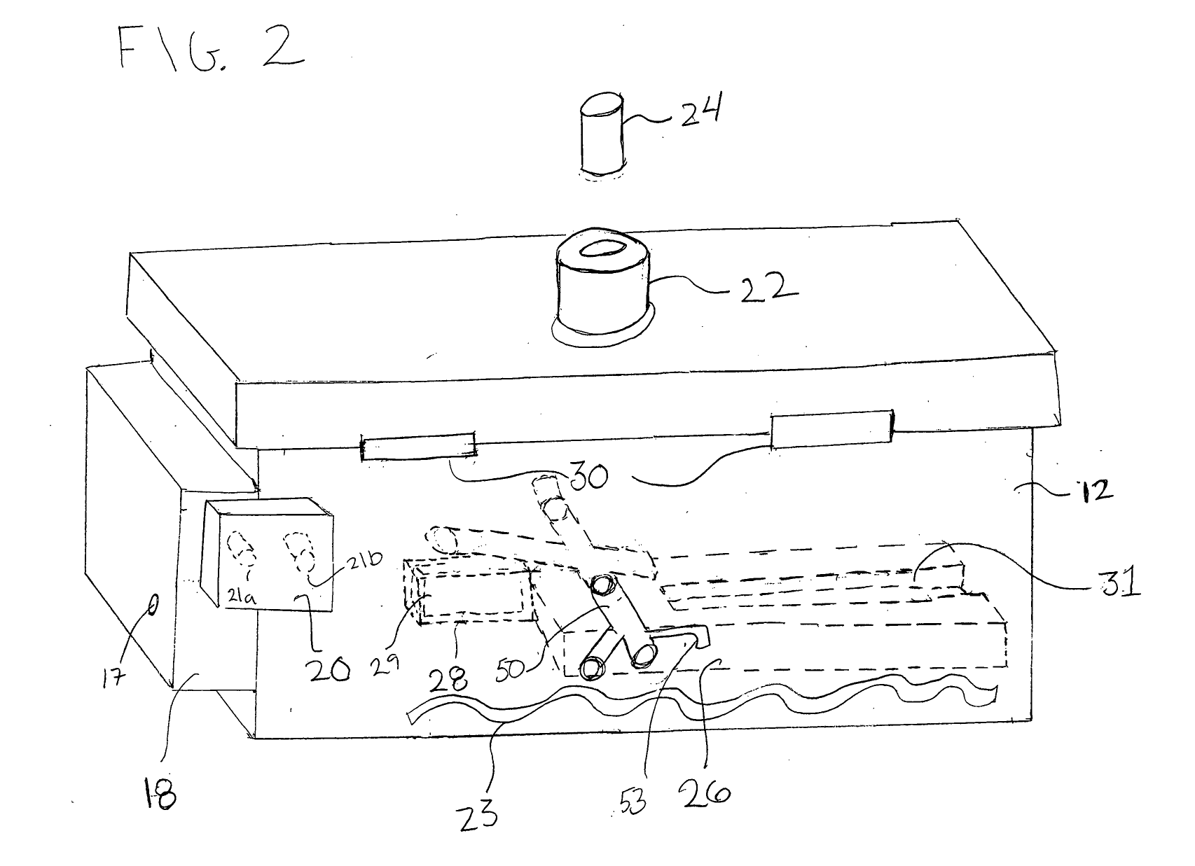

FIG. 2 is a perspective view of one embodiment of the outer chamber 12 of FIG. 1. In one embodiment, the outer chamber 12 is a clear Lucite or similar chamber, in one particular exemplary embodiment having a volume of 902 mL, with 5.8 cm height by 7.7 cm width by 20.2 cm length and thickness 12 mm. The clamps 30 seal the outer chamber shut. A stationary platform 26 includes a track 31 for receiving and positioning the restraint chamber 14. The time constant of the outer chamber 12 is the shortest period that provides a highly repeatable calibration (within 2%), frequency response, and phase matching between pressure and flow signals up to 10-20 Hz. Pressure in the outer chamber 12 is sampled using the low-range (e.g. +/−10 cm H₂O) differential pressure transducer or sensor 20 and referenced to atmospheric reference chamber 18 (τ=6 sec-500 sec). The pressure transducer 20 has a port 21a for connection to the atmospheric reference chamber 18 and a port 21b for connection to the outer chamber 12. The reference chamber 18 has a small leak 17 such that the reference chamber 18 is open to the atmosphere. The outer chamber 12 optionally has a heater, for example, a heat coil 23, and thermometer and can include a humidifier, gas supply, or CO₂ scrubber.

A flow transducer or sensor 29 is positioned within the flow transducer housing 28 or attached to the bottom of the outer chamber, in such a way that it can be attached to the pneumotachograph. The flow transducer housing 28 includes ports for connection to a pneumotachograph and connectors for the flow transducer 29. The flow transducer housing 28 reduces the vibration and noise to the flow transducer 29. The flow transducer 29 measures the flow at the nose of the mouse. The opening 22 and plug 24 are provided to adjust the leak, i.e., the time constant, of the outer chamber 12. By having an adjustable leak, both flow displacement plethymography and pressure displacement plethysmography can be employed. Pressure displacement plethysmography is used when the outer chamber is substantially sealed such that the pressure is measured, and flow displacement plethysmography is used when the outer chamber has a leak such that the flow is measured. The adjustable leak further provides for a user to define the leak and still retain pressure. A more rapid time constant acts as a high pass filter, such that a fast breathing rate is measured, while slow frequency artifacts, i.e., opening and closing the chamber 12 and heat dissipation by the animal, are not measured.

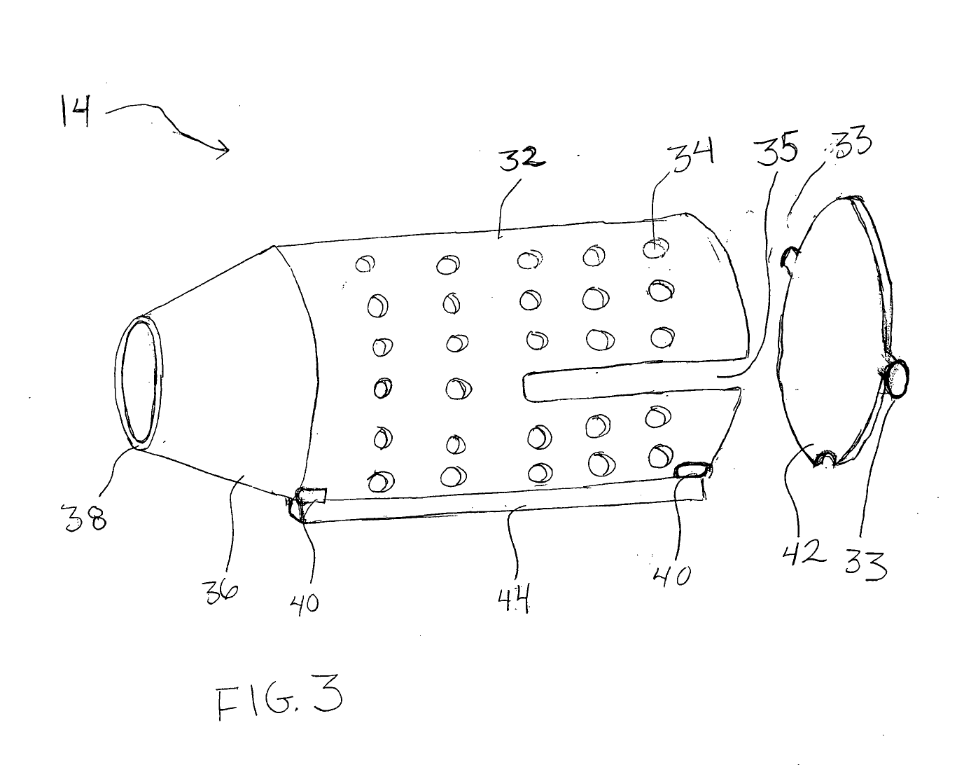

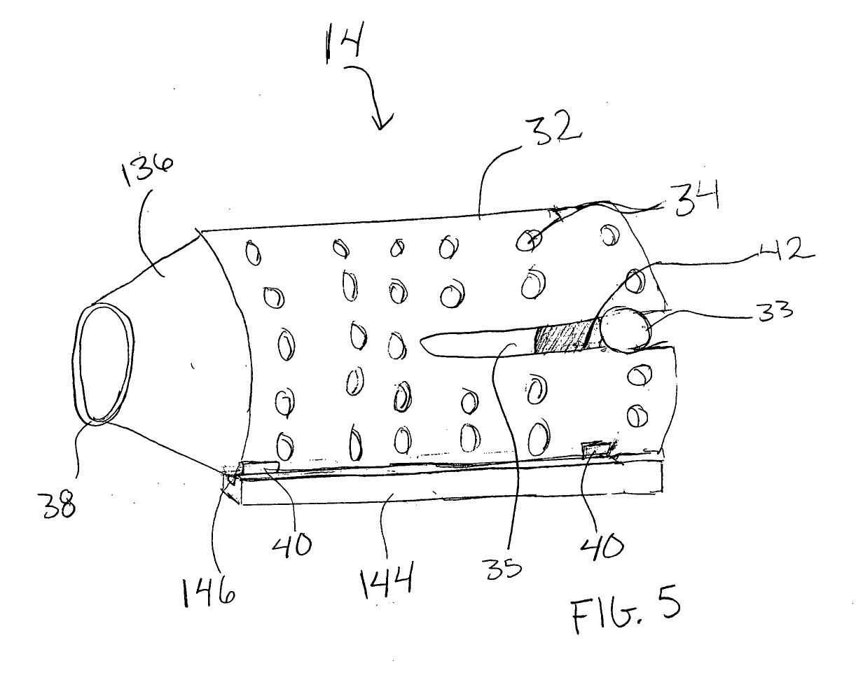

FIG. 3 is a perspective view of an embodiment of the restraint chamber 14 of FIG. 1. The RWBP 10 includes of the restraint chamber 14 for a single mouse within the outer chamber 12. The restraint chamber 14 has a clear porous restraint cylinder 32 having several large holes 34 overlying the region where the thorax and abdomen of the mouse lies, the holes 34 preferably being 2-3 mm in diameter. The holes 34 on all sides of the restraint cylinder 32 dissipate pressure instantaneously, and holes 34 on the bottom of the restraint cylinder 32 permit injections of the mouse. As shown in FIG. 4, the restraint cylinder 32 splits open at the top such that the mouse can be placed in the restraint cylinder 32 and closed into the restraint chamber 14 from the top using hinges 40. Referring to FIGS. 3 and 4, the restraint chamber 14 has a nose cone 36, which is hard or soft, and a thick soft O-ring 38, or alternatively a soft cuff-like inner surface, at a distal end of the nose cone. Alternatively the nose cone could taper to conform sufficiently to the anatomy of the mouse's nose to avoid leak around the nose. In one embodiment, the nose cone is translucent but colored red or amber, so that the mouse senses that it is dark but the mouse can still be seen. The O-ring 38 is preferably formed of silicone or similar materials that are non-irritating. The nose cone 36 allows the nose of the mouse to stick out through the soft O-ring 38 to assure the proper position of the mouse. A neck collar and neck seal are not used in the restraint system. The mouse is positioned to engage their muzzle on the inner wall of the O-ring 38 such that back-leak of flow is prevented. A movable back piece 42 prevents the mouse from backing out of the restraint chamber 14 and has an opening for the mouse's tail. The restraint cylinder 32 includes a slot 35 and the back piece 42 includes a locking knob 33. The locking knob 33 slides along the slot 35 and then locks the back piece in place. The restraint chamber 14 includes a guide 44 which is stationary with respect to the floor of the restraint cylinder 32. The guide 44 is placed in track 31 of the stationary platform 26 and the restraint chamber 14 moves forward along the track 31 until the O-ring 38 locks into a nose cone receiver 48 of the docking station 16, as shown in FIG. 6 described below. Alternatively an additional O-ring placed on the surface of the nosecone that locks into a respective depression in the docking station would function to seal the nosecone from air leaks.

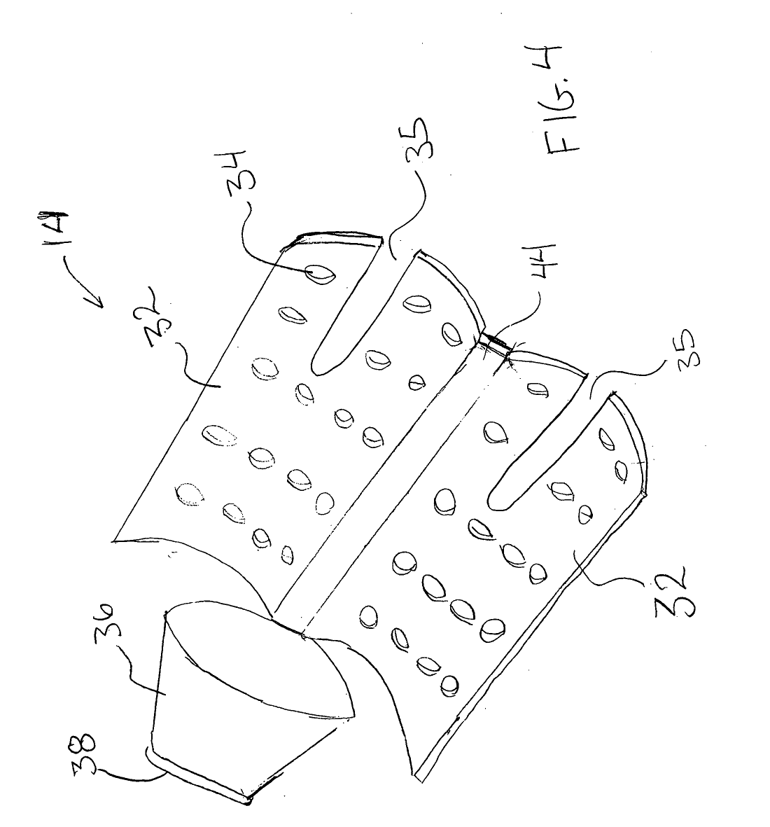

FIG. 5 is a perspective view of an alternative embodiment of the restraint chamber of FIG. 3. In this embodiment, the guide 144 has a sliding track 46. In one embodiment of the present invention, the nose cone 136 moves along the sliding track 146 to slide the nose cone 136 straight over the nose of the mouse and connect with the restraint cylinder 32, so that the mouse is not pushed from the rear. The nose cone 136 and restraint cylinder 32 lock together when the mouse is properly positioned. In another embodiment, the restraint cylinder 32 is moved along the sliding track 146 into the nose cone 136, so that the nose is positioned into the nose cone 136 without pushing the mouse from the rear. The restraint cylinder 32 and nose cone 136 lock together when the mouse is properly positioned. The nose cone 136 and restraint cylinder 32 are locked together due to the friction in the track 146 or the use of a lock-stop mechanism for the track 146.

FIG. 6 is a perspective view of one embodiment of a docking station 16 of FIG. 1 for the purposes of flow plethysmography or venting. The docking station 16 includes of a nose cone receiver 48, an aerosol tube 50 that is an inlet/outlet/stopcock having a low dead space, preferably 0.1-0.2 mL, and a pneumotachograph 52. The aerosol tube 50 extends from one end of the outer chamber 12 to the other end of the outer chamber 12 protruding through both ends. The aerosol tube 50 has one port extending towards the pneumotachograph 52 and another port extending towards the nose cone receiver 48. Other sensors can be added to the docking station. Aerosols are generated with an ultrasonic nebulizer or similar device, and directed through the aerosol tube 50 using a low-flow (e.g. 200 L/min) regulator. A low dead space (less than 0.3 mL) heated 38-39° C. pneumotachograph 52 is fitted to the proximal port of the nose cone receiver 48. The pneumotachograph 52 measures flow and flow-derived parameters. The docking station 16 switches between nebulization of the mouse to flow through the pneumotachograph 52. The nose cone receiver 48 receives the nose cone 36 and O-ring 38 of the restraint chamber 14. In one embodiment the nose cone receiver 48 and the O-ring 38 create a seal. In another embodiment, the nose cone receiver 48 has a slot for interlocking with the O-ring 38 creating a seal. The nose cone receptor and nose cone provide visualization of the seal created for safety reasons. The aerosol tube 50 has up to three positions. The aerosol tube 50 is housed within a larger connector, not shown, made airtight with O-rings that adjoin the pneumotachograph 52, aerosol tube 50, and nose cone receiver 48.

FIGS. 7A, 7B and 7C are perspective views of positions of the aerosol tube of FIG. 6. The position of the aerosol tube or stopcock 50 is changed by the handle 53 as shown in FIGS. 1 and 2. The aerosol tube 50 has an exhaust end 55, an aerosol and injection end 57, a mouse end 59 and a pneomotachograph end 61. In FIG. 7A, aerosol is delivered across the RWBP through aerosol tube 50a from the aerosol end 57a bypassing the pneumotagraph, and the mouse breaths the air containing the aerosol through the mouse end 59a as it passes through the aerosol tube 50a. Further, in FIG. 7A, if the exhaust end 55a of the aerosol tube 50a is blocked off, leak checking in the cuff can be performed. There should be no flow in the aerosol tube 50a when the exhaust end 55a is blocked off, and if there is, a leak is present. In this manner leaks can be tested from outside the apparatus. In FIG. 7B, the pneumotachograph 52 is calibrated. A divider 51 divides air flow in the aerosol tube 50b from the atmosphere, from the aerosol injection end 57b, to the pneumotachograph 52 through the pneumotachograph end 61b. The mouse is open to the atmosphere through the mouse end 59b to prevent lack of air during the calibration of the pneumotachograph 52, however the pneumotachograph 52 may be calibrated without the mouse in the chamber. In FIG. 7C, the airflow in the aerosol tube 50c is between the pneumotachograph 52 and the nose cone receiver 48, or the nose of the mouse, and flow from the animal is measured.

FIG. 8 is a perspective view of the restraint chamber 14 of FIG. 3 and the docking station 16 of FIG. 6 connected with the outer chamber 12 of FIG. 2. The nose cone 36 of the restraint chamber 14 fits into the nose cone receiver 48 of the docking station 16, as shown in FIG. 1, forming a low pressure air seal and decreasing exposure to sound. The track 31 in the stationary platform 26 is provided in the outer chamber to stabilize the restraint chamber 14 and to slide the mouse into the nose cone receiver 48. The position of the mouse is adjusted to optimize nasal seal by movement of the floor separate from the restraint chamber 14 along the track 31. Therefore, the mouse does not have to be pushed from the rear, which causes an adverse reaction in mice. Rather, it slides forward and backward within the restraint tube. Alternatively, a standard back plate can be used to push the mouse forward. The restraint chamber 14 is positioned into the track 31 and slid to connect with the nose cone receiver 48 of the docking station 16 to create a leakless seal. The pneumotachograph 52 is connected to the flow transducer 29 through ports in the flow transducer housing 28, such that flow measurements are made. In another embodiment, other restraint chambers that can be applied to the docking station may be employed.

Experiments using the RWBP 10 will now be described.

The experimental protocol followed NIH guidelines and was approved by the Institutional Animal Care and Use Committee at Tufts University Cummings School of Veterinary Medicine (IACUC Protocol G670-04).

The animals used included pathogen-free female C57BL6 (n=18) (Charles River Laboratories, Wilmington, Mass.), A/J (n=18) and BALBc (n=44) (Jackson Laboratories, Bar Harbor, Me.), purchased at 8-10 weeks of age (19-26 g) were used for this experiment. Each mouse was individually identified; they were housed in cages in groups of 4-5 in an AAALAC accredited facility that provided only Hepa filtered air. Food and water free of ovalbumin was provided ad libitum. A sentinel program ruled out the presence of any of the following infectious agents in the housing area of the mice during the study: Parvoviruses (MPV-1, MPV-2, MVM, NS-1), Sendai virus (SEND), Pneumonia Virus of Mice (PVM), Mouse Hepatitis virus (MHV), Theiler's Murine Encephalitis Virus (TMEV), Reovirus (REO), Mycoplasma pulmonis (MPUL), and Mouse rotavirus (EDIM).

Study Design

In A/J, C57, and BALBc mice, the responses to methacholine aerosol were measured using restrained whole body plethysmography (RWBP) and the FOT technique. In BALBc mice, double chamber plethysmography (DCP) was additionally used. Finally, methacholine responses in the BALBc mice after allergen sensitization and challenge were measured.

Physical Properties of the Restrained Whole Body Plethysmography (RWBP)

The dynamic properties of the plethysmograph were studied by varying pressures in the chamber (John, J., B. Drefeldt, et al. (1994). “Dynamic properties of body plethysmographs and effects on physiological parameters.” J Appl Physiol 77(1): 152-9. (hereinafter John, et al.), incorporated herein by reference). A leak (3.2 sec to 36% peak pressure) was created by a Luer connector mounted in the wall of the box, which was attached to a length of tubing, a stopcock and needle (22 g, 2 cm). The leak resistance was measured to be 5.37 cm H₂O/L/sec and inertance 0.029 s²/mL. A step pressure created by (a) hammering gently the plunger of a syringe loaded to an expected volume (0.02 mL), and (b) balloon burst both peaked between 19-21 msec, with a thermal time constant (described by a single compartment) of 0.95 sec. Amplitude was examined as a function of input frequency using digitally controlled square and sinusoidal flows delivered with a piston-driven mouse ventilator (flexiVent, Scireq Corp, Montreal, Canada). Box pressure amplitude remained within 3% of the delivered volume (0.1 mL) from 1-10 Hz, and within 0.075% between 2 and 5 Hz, the range most relevant to breathing in conscious mice. Therefore the conditions were adiabatic across these frequencies. Time shifts between flow, delivered via the pneumotachograph within the box, and peak box pressure averaged less than 3 msec (range 1-6 msec) from 0.5-20 Hz generated using a broadband input generator (flexiVent, Scireq Corp). Pressure in the plethysmographic chamber was sampled differential pressure transducer 20 (TRD 5700, Buxco Electronics, Wilmington, N.C.) referenced to the atmospheric reference chamber 18 The pneumotachograph 52 (8431 Series, Hans Rudolph, Kansas City, Mo.) heated to 38-39° C. measured flow and flow-derived parameters. Data was sampled at 2500 Hz per channel using commercial hardware (Max1420 Buxco Electronics, PCI 6024E, National Instruments) and software (Biosystem XA version 2.9.4, Buxco Electronics, Inc). The pneumotachograph was calibrated by integration of the flow, injected as a known volume (0.5 mL). Box volume was calibrated by rapid injection of a known volume (0.1 mL) into the chamber between each mouse, and checked repeatedly using injections of varying volumes and quasi-sinusoidal inputs. Bias flow (0.5 L/min) was employed between recordings, and the box vented fully between methacholine challenges.

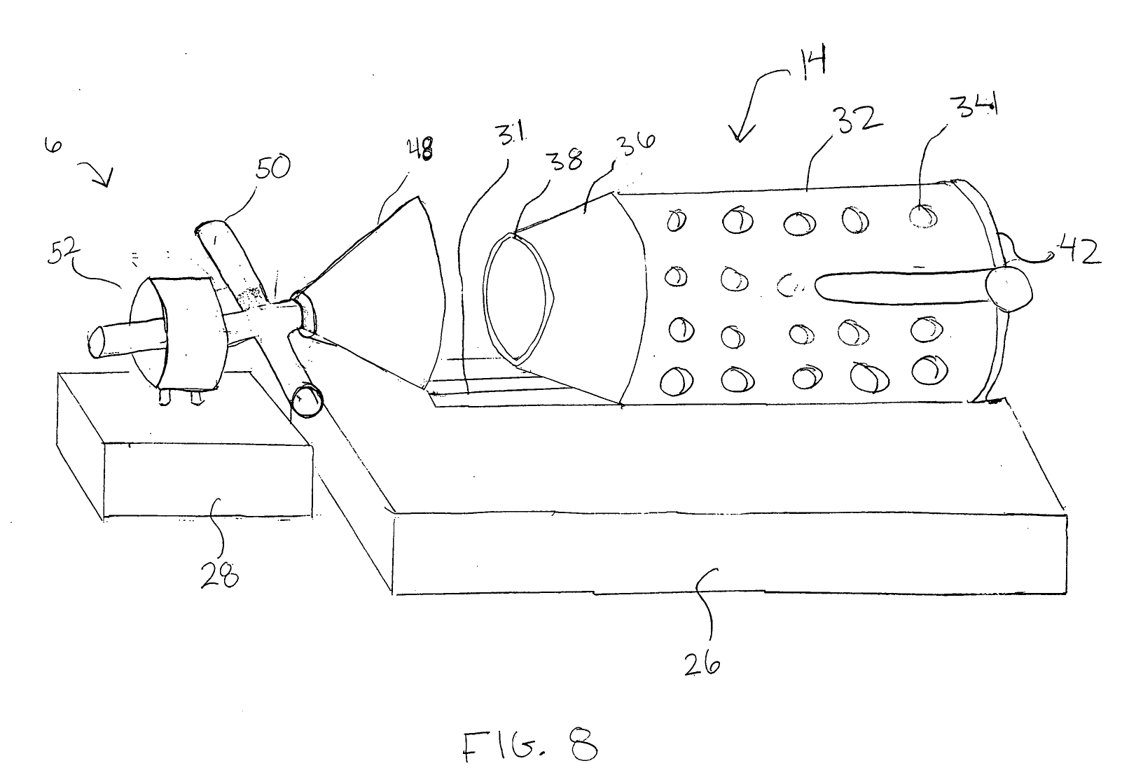

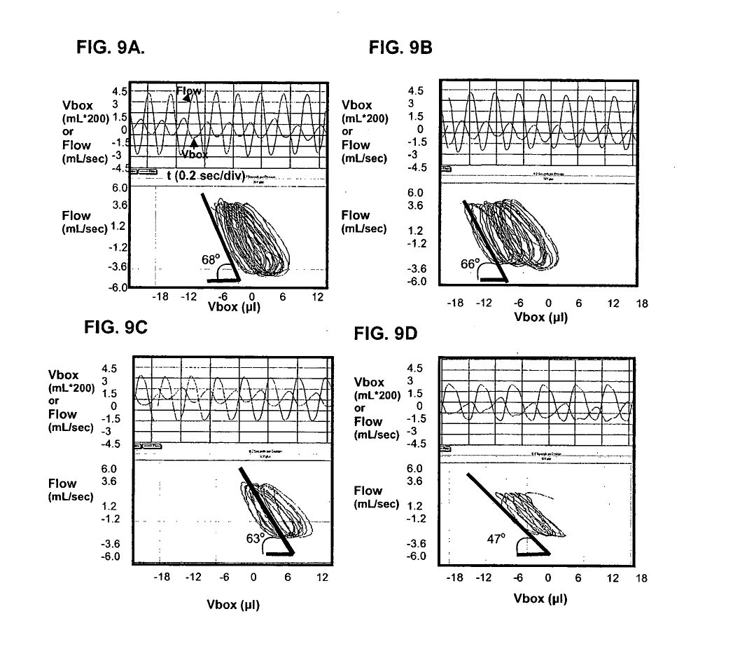

FIGS. 9A-9D are box volume-flow plots for the experiments performed using an RWBP according to the invention. Primary waveforms (box volume, flow) are reviewed and period of peak responses based on EF50 are identified. These occurred regularly between 1.5-2.5 minutes after exposure to methacholine. FIGS. 9A-9D have a stripchart for pneumotachograph flow and plethysmographic volume. Below the stripcharts are corresponding X-Y plots of flow (Y-axis) and box volume shift (X-axis). A slope (θ) of the box volume-flow plot was measured using a protractor (accurate to 0.5 degrees) on the straightest possible segment between −1 to 1 mL/sec. Angles are measured at the transition from expiration to inspiration to minimize the contribution of heating and humidification to the box volume signal (see Agrawal K P). Gains were set to produce angles (tangents) between 40 and 75 degrees. Breaths with evidence of laryngeal braking are avoided. Specific airway resistance (sRaw) is computed from the plots as follows:
sRaw=(1/tan θ)*(Patm−P_{H2O})*Cf*(Vbox−bwt mouse)/Vbox, Equation 1:
where Patm is atmospheric pressure, P_{H2O} is water vapor pressure, Cf is a scaling factor for X and Y axes, Vbox is volume of the outer chamber, and bwt mouse is the weight of the mouse in units of grams.

FIGS. 9A, 9B, 9C and 9D illustrate representative changes in the appearance of pressure-flow loops after methacholine aerosol administration in one C57BL/6 mouse. FIG. 9A was post-saline and average sRaw was 0.68 cm*seconds. In FIG. 9B, the methacholine dose was 10 mg/mL and the average sRaw was 0.75 cm*seconds. In FIG. 9C, the methacholine dose was 50 mg/mL and the average sRaw was 0.86 cm*seconds. In FIG. 9D, the methacholine dose was 100 mg/mL and the average sRaw was 1.61 cm*seconds. At baseline, loops were nearly vertical, but after a methacholine challenge, the loops became more horizontal.

Double Chamber Plethysmography

The double chamber plethysmograph was purchased from a commercial source (PLY3351, Buxco Electronics Inc, Wilmington, N.C.). The techniques for measurement with this technique have been described previously (DeLorme, et al. and Flandre, et al.). The flow for each chamber (nasal and thoracic) of the DCP was calibrated separately by rapid injection of a known volume (0.5 mL) into the chamber; volume was matched by the integration of flow. The accuracy of calibration was checked before each test. The phase lag between the chambers was negligible (<0.01 msec up to 10 Hz). For DCP, mice were loaded into the rear of the thoracic chamber and pushed forward until the head protruded through a hole in a latex neck seal provided with the equipment. Four different sized neck seal openings were used (0.6-1.0 mm), with the smallest size that did not diminish peak flow or minute ventilation (Flandre, et al.) employed for measurements. Once the mouse was secured within the thoracic chamber with the head protruding through an appropriate neck seal, the nasal chamber was attached and bias flow (0.5 L/min) initiated. For measurements, the bias flow was turned off temporarily to maximize signal to noise. Computation of sRaw measured with DCP (hereinafter sRaw-DCP) followed protocols established by Pennock, et al. and later applied to mice by Flandre, et al, whereby the time lag (dT) between the thoracic and nasal flow at zero crossing (during transition between inspiration and expiration) was utilized as follows:
sRaw−DCP=(Ti+Te)/(2π)×(Patm−47)×1.36 2×π×dT/(Ti+Te), Equation 2:
where Ti and Te equal inspiratory and expiratory time (sec) and Patm atmospheric pressure (cm H₂O). The peak dT was identified and 10 sequential breaths free from movement artifacts were measured for that period.
Measurements of Respiratory System Impedance Using the Forced Oscillation Technique

The methods for FOT have been previously described in Tomioka, S., J. H. Bates, et al. (2002). “Airway and tissue mechanics in a murine model of asthma: alveolar capsule vs. forced oscillations.” J Appl Physiol 93(1): 263-70. (hereinafter Tomioka, et al.), incorporated herein by reference. Mice were anesthetized with ketamine (50 mg/kg) and xylazine (5 mg/kg) (Butler Co, Dublin, Ohio) intra-peritoneally, and a tracheostomy performed with a 19 g cannula (Becton Dickinson and Company Franklin Lakes, N.Y.). Mice were paralyzed with pancuronium (1 mg/ml, Baxter Healthcare Corp. Irvine, Calif.). Supplemental xylazine and ketamine (½ doses) were provided every ½ hour. Ventilation was set at frequency of 200 BPM, V_{T} 0.3 ml, positive end-expiratory pressure (PEEP) 3.0 cm H₂0, and oxygen was supplemented throughout. Repeated measurements were performed with a commercial data acquisition system for input impedance between 1-20 Hz (Quick Prime 3 analyzer, FlexiVent System, SCIREQ Corp, Montreal, Quebec). A constant phase model (Gomes, R. F., X. Shen, et al. (2000). “Comparative respiratory system mechanics in rodents.” J Appl Physiol 89(3): 908-16 (hereinafter Gomes, et al.)., incorporated herein by reference) was employed to obtain airway resistance Raw, tissue resistance coefficient Gti, and tissue elastance coefficient Hti.

Reproducibility of Baseline (Unprovoked) Measurements

A subset of C57BL/6 mice (n=12) were initially used to examine reproducibility (within-animal, within-group) of sRaw and EF50. Several recordings were made over 45 minutes, on a separate day in the AM and PM (10 min each), and on a third day for 10 min. For each time-point an average of 10 breaths selected at random was used for analysis. The results were expressed as coefficient of variation (CV) and 95% confidence intervals (see Statistical analyses). The within group CV was also compared between strains of mice.

Methacholine Challenges in Conscious Mice

Challenges were conducted at the same time of day (morning or afternoon) for each mouse. Ambient temperatures in the laboratory ranged from 21-23° C. and humidity ranged from 25-45%. Baseline recordings were obtained after 2 min acclimation to the chamber. For aerosol exposures, the mice within their restraint chambers were detached from the pneumotachograph, and attached to an adjacent enclosure set up for nose-only exposures. For RWBP, aerosols were generated with an ultrasonic nebulizer (Aerogen, Aeroneb, Dangan, Galway, Ireland), and directed through the aerosol tube 50 using a low-flow (470 mL/min) regulator, thus permitting the mice to breath a standardized aerosol concentration (reported mass median diameter=3.1 microns). Following each exposure, mice were returned to the RWBP, and the recording of data resumed for 5 min. For DCP, aerosols were delivered from the Aerogen nebulizer directed via aerosol tube 50 into the nasal chamber. Bias flow caused the aerosol to traverse the nasal chamber at the level of the nares, assuring exposure to the aerosol. Doses of methacholine were chosen that induced on average an increase in sRaw-RWBP to 300% baseline. Specifically, methacholine (Provocholine, Methapharm, Brantford, Ontario) was nebulized for 60 seconds to C57 at concentrations of 0 (i.e., saline), 10, 50, and 100 mg/mL, in A/J mice at 0, 1, 5, and 10 mg/mL, and in BALBc mice at 0, 6.25, 12.5, and 25 mg/mL (pre and post OVA exposure). The provocative concentration that caused sRaw to increase to >175% post-saline value was computed by log-linear interpolation across the final two concentrations of methacholine employed for each mouse, according to Sterk, P. J., L. M. Fabbri, et al. (1993). “Airway responsiveness. Standardized challenge testing with pharmacological, physical and sensitizing stimuli in adults. Report Working Party Standardization of Lung Function Tests, European Community for Steel and Coal. Official Statement of the European Respiratory Society.” Eur Respir J Suppl 16: 53-83., incorporated herein by reference.

The provocative concentration of methacholine that increased sRaw to 175% post-saline values (‘ED175’) was used as an index of airway reactivity.

Methacholine Challenges in Anesthetized Mice Using Forced Oscillation Technique (FOT)

Aerosols were delivered directly into the tracheal cannula during lung inflation during mechanical ventilation (flexiVent, Scireq Corp, Montreal, Quebec). Ten second nebulization periods were used, followed immediately by a series (8-15) of measurements. Prior to each measurement of lung mechanics, the lung was inflated to total lung capacity (TLC) (30 cm H₂O airway pressure). Forced oscillations during apnea (3 seconds in duration) were applied every 17 seconds for 5 minutes. Dosage ranges were pre-determined in pilot studies to evoke between 10 and >75% increase in airway resistance (Raw). Methacholine in C57 mice was delivered at 0 (saline), 4, 8, and 16 mg/mL, and in AJ we used 0, 2, 4, and 8 mg/mL. The concentration of methacholine that provoked an increase in Raw-FOT to 175% baseline (ED 175) was determined by log-linear interpolation as described above.

Allergen Sensitization and Aerosol Exposure of BALBc Mice

A subset of the BALBc mice (n=8) were immunized and sensitized to ovalbumin using a procedure modified from past studies (Temelkovski, J., S. P. Hogan, et al. (1998). “An improved murine model of asthma: selective airway inflammation, epithelial lesions and increased methacholine responsiveness following chronic exposure to aerosolised allergen.” Thorax 53(10): 849-56., incorporated herein by reference, Kumar, R. K., C. Herbert, et al. (2004). “Reversibility of airway inflammation and remodelling following cessation of antigenic challenge in a model of chronic asthma.” Clin Exp Allergy 34(11): 1796-802., incorporated herein by reference, Kumar, R. K., C. Herbert, et al. (2004). “Effects of anticytokine therapy in a mouse model of chronic asthma.” Am J Respir Crit Care Med 170(10): 1043-8., incorporated herein by reference). Briefly, mice received an intraperitoneal injection of 50 ug ovalbumin (grade V, 98% pure, Sigma Aldrich, St Louis, Mo.) precipitated in aluminum hydroxide and magnesium hydroxide (Imject Alum, Pierce, Rockford, Ill.) 14 and 7 days before inhalational exposure. Mice were then exposed to 2.5% aerosolized ovalbumin for 30 minutes three times a week for two weeks. Inhalation exposures were performed using a custom-built whole body exposure system during which air was drawn through a 0.4 cubic meter chamber at a flow rate of 80 l/min. The ovalbumin solution was delivered into the chamber using a Pari LC JET fine particle nebulizer (Pari Corp, Paris, France) delivering particles with reported mean median diameter of 1.6 um, and compressor (Model NE-CO8, Omron Healthcare, Inc, Vernon Hills, Ill., USA). The mass concentration of the particles within the breathing zone of the mice was continuously monitored using a laser photometer (SidePak, AM510, TSI Inc, Shoreview, Minn.). Flow from the compressor was regularly adjusted throughout the exposure period in order to keep the ovalbumin concentration between 3 and 6 mg/m³.

Statistical Analyses

The intra-animal and within-group reproducibility of non-invasive sRaw versus invasive Raw were expressed as coefficients of variation (CV) and 95% confidence limits, and time effects tested using repeated measures univariate analysis (ANOVA). The methacholine responses were analyzed using repeated measures ANOVA. The effect of mouse strains on sRaw-RWBP, sRaw-DCP, Raw-FOT, or indices of airway reactivity (ED 175) was analyzed using ANOVA. Pairwise comparison between strains was performed using Student's T-tests. Paired tests were employed to test the effect of allergen on ED175 in BALBc mice. Significance was attributed to data when P<0.05. All values are expressed as mean±SEM except where indicated.

In the following section results of experimentation are described.

Reproducibility of sRaw Using Restrained Whole Body Plethysmography

In the group of C57 mice used to study repeatability, there were no significant changes in sRaw-RWBP within the 45 minute measurement periods, between AM and PM measurements, or between different experimental days (Table 1).

TABLE 1
Specific airway resistance (sRaw) measured repeatedly in a group of conscious
C57 mice (n = 12) using restrained whole body plethysmography.

| | Time | | | | | | | |
|---|---|---|---|---|---|---|---|---|
| | | | | | Day 1 | Day 1 | | |
| | 0 min | 10 min | 30 min | 45 min | AM | PM | Day 2 | Day 3 |
| Mean-sRaw | 0.573 | 0.609 | 0.544 | 0.564 | 0.619 | 0.556 | 0.602 | 0.645 |
| (cmH₂0*s) | | | | | | | | |
| SD-sRaw | 0.101 | 0.100 | 0.132 | 0.128 | 0.095 | 0.127 | 0.088 | 0.052 |
| (cmH₂0*s) | | | | | | | | |
| Coefficient of | 17.6 | 16.5 | 24.3 | 22.7 | 15.4 | 22.8 | 14.6 | 8.1 |
| Variation (%)^{a} | | | | | | | | |
| 95% C.I. cmH₂0*s | 0.057 | 0.057 | 0.075 | 0.072 | 0.054 | 0.072 | 0.05 | 0.030 |

^{a}Within-group (within time period).

The mean intra-animal CV over the short term (i.e., 3 measurements evenly spaced over 45 minutes) was 6.8% for sRaw-RWBP and for Raw-FOT it was 3.4% (for 3 successive measurements). The mean intra-animal CV for Raw-FOT was significantly lower (P<0.05). The mean intra-animal CV in the longer term (across days 1, 2, and 3) was 22.8% for sRaw-RWBP. The inter-animal CV for sRaw-RWBP for this set of C57 mice on days 1, 2, and 3, were 26%, 27%, and 14%, respectively (mean 22.3%). For the subsequent groups used in methacholine challenges, the inter-animal group CV for sRaw-RWBP was 26.5% for C57, 17.2% for AJ, and 30.2% in BALBc mice (pre-OVA). In comparison, inter-animal CV for Raw-FOT was 19.5% for C57 and 20.7% for A/J. Therefore the reproducibility of these techniques was very similar.

Methacholine Responses

Measurement of sRaw-RWBP took between 3-6 minutes including loading, and methacholine challenges took between 16-30 minutes depending on airway reactivity. Baseline sRaw-RWBP was significantly lower (P<0.001) in C57 compared to AJ or BALBc (Table 2).

TABLE 2
Baseline measurements of conscious and invasive physiology by strain of mice.
Values shown were derived from C57 (n = 18), A/J (n = 18), and BALBc (n = 18) mice, and
an additional group of BALBc before and after allergen exposure (n = 8). Methods used
were restrained whole body plethysmography (RWBP) and the forced oscillation
technique (FOT).

| | RWBP | | | | | | | | FOT | | |
|---|---|---|---|---|---|---|---|---|---|---|---|
| Strain | sRaw | F | V_{T} | V_{E} | PEF | PIF | Ti | Te | Raw | Gti | Hti |
| C57 | 0.509 ± 0.033 | 357.7 ± 0.02 | 0.281 ± 0.014 | 100.3 ± 0.02 | 4.90 ± 0.02 | 4.36 ± | 0.089 ± | 0.082 ± | 0.35 ± | 5.28 ± | 28.84 ± |
| | | | | | | 0.02 | 0.03 | 0.01 | 0.02 | .92 | 6.72 |
| A/J | 0.676^{a} ± 0.027 | 277.9^{a} ± 0.03 | 0.245^{a} ± 0.06 | 67.7^{a} ± 0.06 | 3.27^{a} ± 0.05 | 2.92^{a} ± | 0.109^{a} ± | 0.108^{a} ± | 0.35 ± | 4.95 ± | 21.94^{a} ± |
| | | | | | | 0.05 | 0.02 | 0.03 | .03 | .049 | 1.82 |
| BALBc | 0.633^{a} ± 0.045 | 327 ± 5.5 | 0.210^{a} ± 0.007 | 67.1^{a} ± 2.79 | 3.25^{a} ± 0.13 | 3.04^{a} ± | 0.0964 ± | 0.109^{a} ± | n/d | n/d | n/d |
| (no-OVA) | | | | | | 0.12 | 0.0018 | 0.045 | | | |
| BALBc | 0.679^{a} ± 0.061 | 287^{a} ± 13.5 | 0.282 ± 0.017 | 81^{a} ± 3.9 | 3.61^{a} ± 0.16 | 3.53^{a} ± | 0.106^{a} ± | 0.104^{a} ± | n/d | n/d | n/d |
| (PRE) | | | | | | 0.14 | 0.003 | 0.003 | | | |
| BALBc | 0.63^{a} ± 0.058 | 326 ± 7.7 | 0.276 ± 0.011 | 101 ± 3.4 | 5.2 ± 0.23 | 4.53 ± | 0.094 ± | 0.089 ± | n/d | n/d | n/d |
| (POST) | | | | | | 0.14 | 0.003 | 0.002 | | | |

The values are mean ± SEM, and wherein sRaw is specific airway resistance, cmH₂O*s;
f is respiratory rate in breaths/min;
V_{T} is tidal volume in ml;
V_{E} is minute ventilation in ml/min;
PEF is peak expiratory flow in ml/s;
PIF is peak inspiratory flow in ml/s;
Ti is duration of inspiration in seconds;
Te is duration of expiration in seconds;
Raw is resistance of airways in cmH₂O/mL/sec;
Gti is tissue resistance in cmH₂O*ml⁻¹;
Hti is elastance in cmH₂O*ml⁻¹;
^{a}denotes a significant difference from C57 mice (P < 0.05).

Baseline Raw-FOT was not different between AJ (0.35±0.12 cm/mL/sec), C57 (0.35±0.16 cm/mL/sec), and BALBc (0.30±0.06 cm/mL/sec) mice. The mean±SEM functional residual capacity (FRC) determined in a separate group of C57 mice (n=30) was 0.265±0.009 mL. These values were used to construct sRaw-FOT (see Discussion for assumptions and calculations).

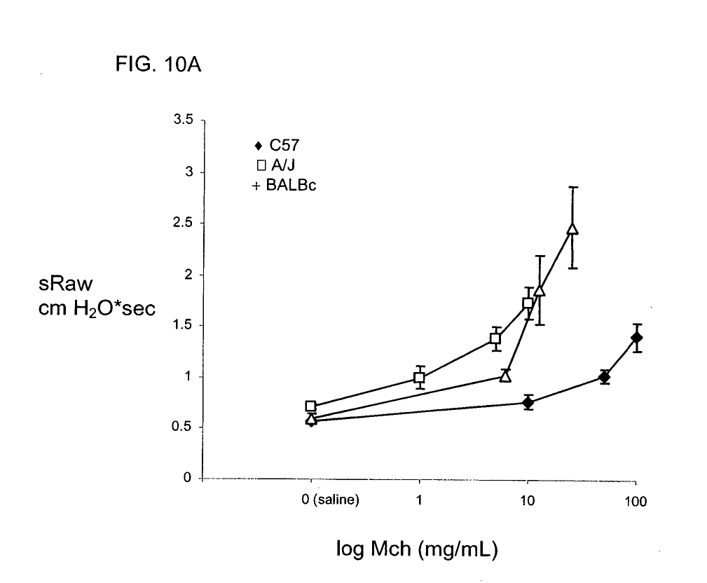

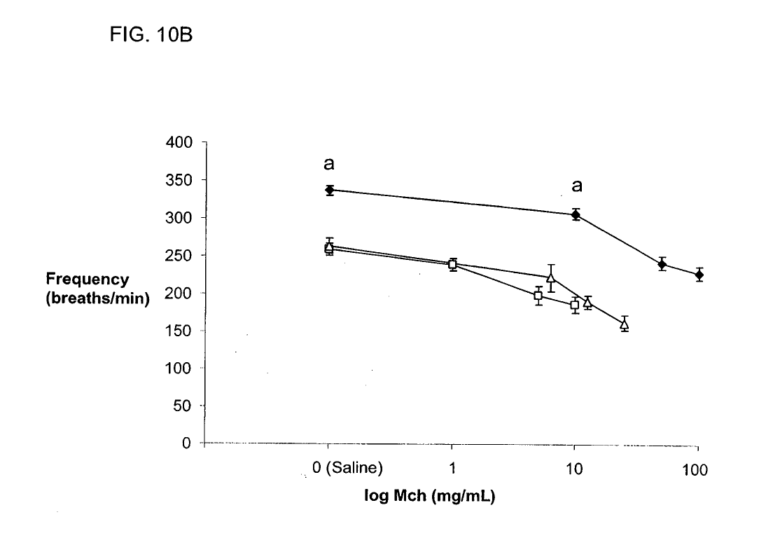

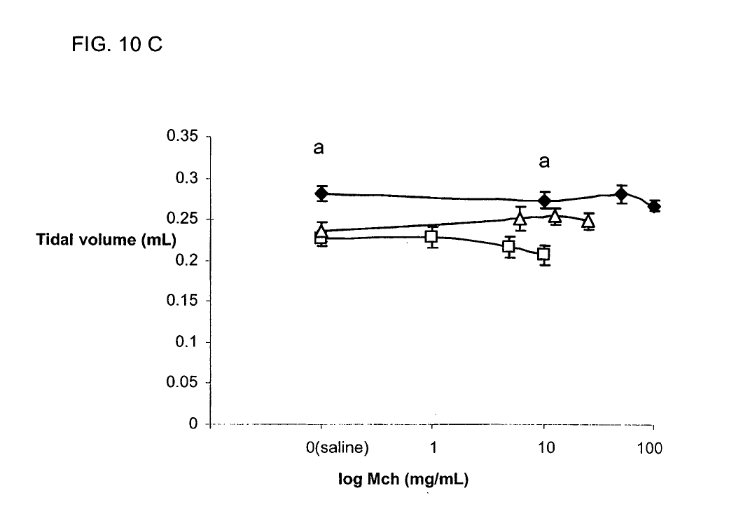

FIGS. 10A, 10B and 10C are dose response curves of experiments performed with an RWBP according to an embodiment of the invention. FIGS. 10A, 10B and 10C are dose responses to methacholine in conscious C57 (closed diamonds ♦), AJ (n=18, open squares□), and BALBc (n=18, open triangle Δ) mice. Statistical significance between C57 and A/J mice at equivalent doses of methacholine are indicated by “a”. FIG. 10A is a dose response curve for sRaw for the three strains of mice. FIG. 10B is a dose response curve for breathing frequency for the three strains of mice. FIG. 10C is a dose response curve for tidal volume for the three strains of mice. Methacholine caused a significant dose-dependent increase in sRaw-RWBP (FIG. 10A). Accompanying the change in sRaw-RWBP was a significant decrease in respiratory frequency but no change in tidal volume for any strain of mice (FIGS. 10B and 10C).

FIG. 11 is a dose response curve of experiments performed with a FOT technique. In FIG. 11, methacholine caused a dose-dependent increase in Raw in all 3 strains of mice. FOT was performed in anesthetized, tracheotomized C57 (n=18, closed diamonds ♦), AJ (n=18, open squares □), and BALBc (n=10, open triangle Δ) mice. Shown in FIG. 11 are saline (0 mg/mL methacholine) followed by methacholine concentrations which depended on the strain of the mice. Significant differences between strains at equivalent doses is signified by ‘a’. Airway reactivity was significantly different between AJ, C57, and BALBc mice for sRaw-RWBP and the descending order of reactivity was AJ>BALBc>C57.

Using Raw-FOT, there was no difference between C57 and BALBc ED175, but both strains had a significantly higher ED175 than A/J. Therefore airway reactivity in descending order by FOT was A/J>BALBc=C57.

The results of baseline measurements of conscious and invasive physiology by strain of mice are shown in Table 3.

TABLE 3
Measures of airway reactivity in three strains of mice. Airway reactivity
was measured using RWBP, forced oscillation technique (Raw),
restrained whole body plethysmography (sRaw-RWBP), and double
chamber plethysmography (sRaw-ECP). The provocative concentration
that caused an increase in Raw or sRaw to 175% baseline (ED175) is
expressed as the mean and 95% confidence interval.

| | | Raw | sRaw-RWBP | sRaw-DCP |
|---|---|---|---|---|
| | | ED175 | ED175 | ED175 |
| Groups | n | (mg/mL) | (mg/mL) | (mg/mL) |
| C57 | 18 | 8.3 | 40.5^{b} | — |
| | | (6.5-10.2) | (26.9-54.2) | |
| AJ | 18 | 2.3^{a} | 4.49^{a,b} | — |
| | | (1.5-3.1) | (3.1-5.9) | |
| BALBc | 18 | — | 10.9^{a} | — |
| (no OVA) | | | (7.8-13.9) | |
| BALBc | 8 | 9.48 | 9.2 | 7.1^{a} |
| (pre-OVA) | | (6.2-12.8) | (5.3-13.1) | (4.9-9.3) |
| BALBc | 8 | — | 5.0^{a,c} | |
| (post-OVA) | | | (1.8-8.1) | |

Raw is airway resistance mesured using FOT;
sRaw-RWBP is specific airway resistance measured with RWBP;
sRaw-DCP is specific airway resisistance mesured using DCP;
ED175 is provocative dose to increase Raw or sRaw to 175% post-saline value;
no OVA is a group of mice with no sensitization or exposure to ovalbumin;
BALBc (pre-OVA) is a group of mice prior to sensitization and aerosol exposure to ovalbumin;
BALBc (post-OVA) is 48 hrs following allergen challenge in sensitized group;
^{a}denotes a significant difference from C57 mice (P < 0.01);
^{b}denotes a significant difference from EC175 for Raw for same strain mice (P < 0.01);
^{c}denotes a significant difference from BALBc (pre-ova) by Paired T Test (P < 0.05).

significant difference from EC175 for Raw for same strain mice (P<0.01); ^{c} denotes a significant difference from BALBc (pre-ova) by Paired T Test (P<0.05).

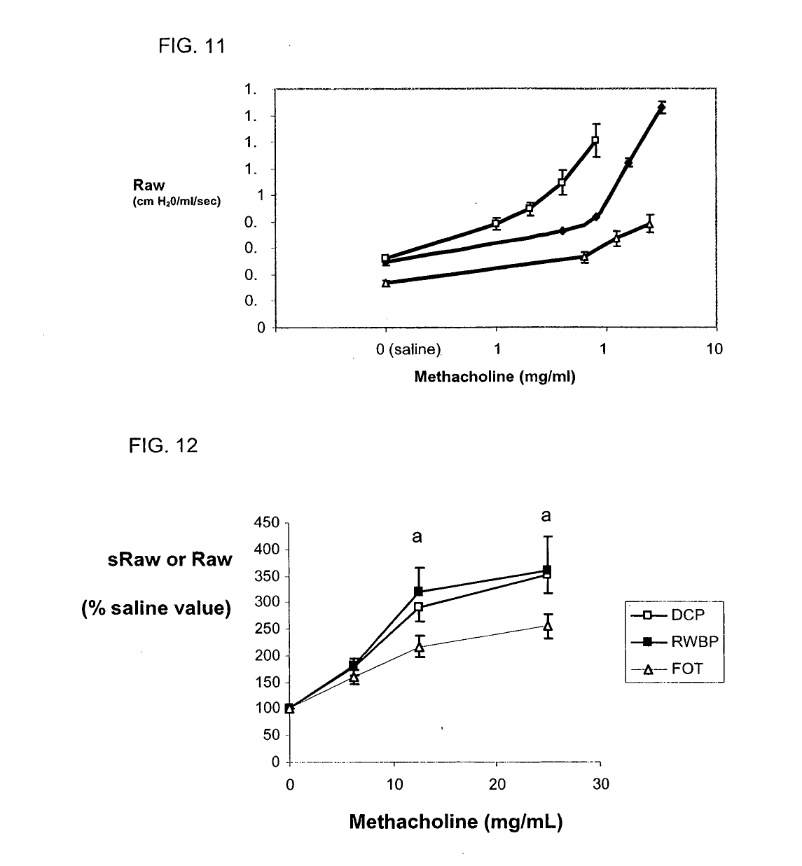

FIG. 12 is a comparison of methacholine responses between methods using a single strain of mouse (BALBc) and standard doses for methacholine is shown in FIG. 12. Conscious methods include restrained whole body plethysmography (sRaw-RWBP) and double chamber plethysmography (sRaw-DCP). The invasive method includes the FOT technique which produces Raw-FOT. Significant differences (P<0.001) between RWBP, or DCP, and FOT are signified by the letter ‘a’. Differences were observed at the maximal doses.

Both conscious methods showed a significantly (P<0.01) higher ‘maximal’ (i.e. plateau) response than Raw-FOT at concentrations 12.5 and 25 mg/mL; however, there were no difference between conscious methods. In absolute terms, baseline sRaw-RWBP (0.63±0.05 cm*sec) was significantly (P<0.001) lower than sRaw-DCP (1.82±0.11 cm*sec).

Allergen Responses

In BALBc mice exposed to ovalbumin for 2 weeks, there was no significant change (P>0.1) in baseline sRaw (pre: 0.77±0.04 vs. post: 0.63±0.06 cm*sec). There was a significant (P=0.037) decrease in ED175 (from 9.2 to 5.0 mg/mL) following 2 week of ovalbumin challenge in immunized mice (Table 3).

This study demonstrated for the first time, the application of whole body plethysmography in conscious mice, as originally described by Dubois, Botelho, and Comroe (DuBois, et al.). Whole body plethysmography akin to the technique performed in humans for measurement of sRaw was first adapted for animals by Agrawal K P who used conscious guinea pigs (Agrawal K P, Griffiths-Johnson, D. A., P. J. Nicholls, et al. (1988). “Measurement of specific airway conductance in guinea pigs. A noninvasive method.” J Pharmacol Methods 19(3): 233-42. (hereinafter Griffiths-Johnson), incorporated herein by reference, and Finney, M. J. and K. I. Forsberg (1994). “Quantification of nasal involvement in a guinea pig plethysmograph.” J Appl Physiol 76(4): 1432-8. (hereinafter Finney, et al.), incorporated herein by reference). More recently WBP for direct determination of sRaw has been employed in dogs Bedenice, D., E. Rozanski, et al. (2005). “Canine awake head-out plethysmography (HOP): Characterization of external resistive loading and spontaneous laryngeal paralysis.” Respir Physiol Neurobiol., incorporated herein by reference) and sheep (Bedenice, D., E. Bar-Yishay, et al. (2004). “Evaluation of head-out constant volume body plethysmography for measurement of specific airway resistance in conscious, sedated sheep.” Am J Vet Res 65(9): 1259-64., incorporated herein by reference) using a head-out configuration. Therefore, WBP holds promise for characterization of airway mechanics in conscious animals. Measurement of sRaw appears to be an appropriate endpoint for methacholine responses since it combines information related to airway resistance and lung volume, both of which can be modified during tidal breathing after bronchoconstriction.

Advantages of RWBP may include the ease of loading, nose-only exposure, direct non-plethysmographic measurement of flow, and the lack of a neck seal that may constrict the airway or impair loading. For use of RWBP, none of the mice required acclimation in order to complete several sets of baseline measurements and one ore more bronchoprovocations. While indices of stress were not specifically measured directly, and therefore it is not possible to comment on their physiologic responses to RWBP, the mice were active, grooming, and appeared unharmed each time they were removed from the chamber.

Critique of the Plethysmographic Device

The size of the box (902 mL, or 45 mL/g) was relatively large in comparison to past studies employing pressure plethysmographs in guinea pigs or mice (Vinegar, A., E. E. Sinnett, et al. (1979). “Dynamic mechanisms determine functional residual capacity in mice, Mus musculus.” J Appl Physiol 46(5): 867-71. (hereinafter Vinegar, et al.), incorporated herein by reference, and Sinnett, E. E., Jackson A C, Leith D E, and Butler J P. (1981). “Fast integrated flow plethysmograph for small mammals.” J appl Physiol: Respirat. Environ. Exercise Physiol. 50(5): 1104-1110. (hereinafter Sinnett, et al.), incorporated herein by reference. This contributed to consistent adiabatic conditions, a acceptable feature of pressure plethysmography (Sinnett, et al. and John, et al.). One problem was frequent drift in the baseline of the pressure signal due to warming of the chamber by reloading of the mouse. This could be avoided in future experiments by conducting the entire study without opening the chamber, i.e. aerosolizing agonists to the mice within the chamber using special delivery systems (Agrawal K P and Finney, et al.). Incorporation of heating elements or warmed water (Pennock, et al., Lundblad, et al., and Lai-Fook, S. J. and Y. L. Lai (2005). “Airway resistance due to alveolar gas compression measured by barometric plethysmography in mice.” J Appl Physiol 98(6): 2204-18., incorporated herein by reference) or decreasing the size or thickness of the chamber walls, may also serve to stabilize the thermal conditions of the box interior. Alternatively, flow-type plethysmography has been described (Sinnett, et al.) which would minimize the effects of baseline thermal drift, although pose additional challenges, e.g. maintaining calibration.

A significant challenge in the use of any plethysmograph is to understand the confounding influence of heating and humidification on the box pressure signal. Heating and humidification of inspired gas likely created some looping in the XY plots (Jaeger, M. J. and A. Bouhuys (1969). “Loop Formation in Pressure vs. Flow Diagrams Obtained by Body Plethysmographic Techniques.” Progr. Resp. Res. 4: 116-130., incorporated herein by reference). However, this source of looping would not necessarily interfere with the measurements of sRaw. This is because the pressure-flow tangents were measured during a short period (12 mseconds) when volume shifts were presumably negligible. There is ample evidence that the tangent measured at this point in the non-panting individual provides sRaw that is equivalent to sRaw in the panting individual where gas conditioning is complete (Agrawal K P, Krell, W. S., K. P. Agrawal, et al. (1984). “Quiet-breathing vs. panting methods for determination of specific airway conductance.” J Appl Physiol 57(6): 1917-22., incorporated herein by reference, and Chong, B. T., D. K. Agrawal, et al. (1998). “Measurement of bronchoconstriction using whole-body plethysmograph: comparison of freely moving versus restrained guinea pigs.” J Pharmacol Toxicol Methods 39(3): 163-8., incorporated herein by reference). In sum, there are several improvements that could be made to the current design to improve stability and convenience, but none of these would improve fundamental accuracy of sRaw derived by RWBP.

Reproducibility Observations

An understanding of test reproducibility is paramount to the application of any device used to measure pulmonary function. The intra-animal CV for sRaw-RWBP in mice was 6.6% was similar to guinea pigs (Griffiths-Johnson), and very similar to Raw-FOT (3.4%) as measured. In comparison, impedance measurements showed CV of 9% for the real component of transfer impedance (Hessel, et al.). The within-group CV's were equivalent for sRaw-RWBP and Raw-FOT in the multiple strains of mice in this study. In sum, sRaw-RWBP was no less reproducible at baseline or after methacholine than Raw, despite the fact that the measurement was made without control of several important factors such as tidal volume and PEEP.

Baseline Measurements of sRaw (RWBP, DCP, and FOT)

The measurements using FOT were employed to understand the differences between invasive and conscious measures of sRaw (prior to challenge) and airway reactivity. The baseline values for Raw in both C57 and AJ strains were comparable to previously published values (Gomes, et al., Pillow, J. J., T. R. Korfhagen, et al. (2001). “Overexpression of TGF-alpha increases lung tissue hysteresivity in transgenic mice.” J Appl Physiol 91(6): 2730-4., incorporated herein by reference, and Bozanich, E. M., R. A. Collins, et al. (2005). “developmental changes in airway and tissue mechanics in mice.” J Appl Physiol. (hereinafter Bozanich, et al.), incorporated herein by reference). A direct comparison between the absolute values for sRaw-RWBP and Raw-FOT is complicated by our use of different groups of mice for measurement of baseline Raw-FOT and FRC, and numerous differences in the conditions (e.g. anesthesia, body position, lung volume) under which conscious and FOT measurements were made. However, the measurements of this study can be employed (and published findings) in C57 mice to derive a value of sRaw in anesthetized mice from Raw-FOT. Assuming that sRaw=Raw*FRC, the measurements from this study of FRC (0.27) which are very close to published values in C57 (0.25 mL) (Tankersley, C. G., R. S. Fitzgerald, et al. (1994). “Differential control of ventilation among inbred strains of mice.” Am J Physiol 267(5 Pt 2): R1371-7., incorporated herein by reference) can be used for this calculation as follows: 0.353 cm H₂O/mL/sec*0.27 mL or 0.095 cm*sec. In another study using FOT, sRaw in 8 wk old BALBc mice was 0.13 cm*sec (Bozanich, et al.), although end-expiratory lung volume was measured at higher lung volume. Assuming that invasive sRaw derived by this method is approximately ¼ of total sRaw, the total sRaw derived in the anesthetized C57 of this study would be 0.38 cm*sec. These values for invasive sRaw would likely underestimate conscious sRaw because anesthesia depresses functional residual capacity by about 0.1 mL (Vinegar, et al.). The mean sRaw values in our study, 0.51 cm H₂O*sec for C57, would therefore be very comparable to the invasive derived values in C57 mice, notwithstanding the incalculable differences between the unconscious and conscious states. Another approach to the validity of the baseline measurements was comparison between sRaw-RWBP and sRaw-DCP. In BALBc mice where both techniques were performed, sRaw-RWBP (0.63±0.05 cm*sec) was significantly lower than sRaw-DCP in our study (1.82±0.11 cm*sec), and lower than past measures of sRaw-DCP in BABLc mice, i.e. 1.02 (Flandre, et al.), 1.18±0.4 (Faisca, et al.) and 1.50 (DeLorme, et al.) cm H₂O*sec. The studies values for sRaw-RWBP were also lower than sRaw-DCP in other strains of mice, i.e. 1.2 (Flandre, et al.) or 1.44±0.5 (Faisca, et al.) cmH₂O*s in C57, and 1.68 cm H₂O*sec in AJ mice (Flandre, et al.). The higher values across the board for sRaw-DCP when compared to sRaw-RWBP may relate to differences in the computation methods, and the constrictive effect of the neck seal used for DCP. The computation for DCP is based entirely on nasal vs. thoracoabdominal phase lag, which may be influenced by several instrument and host factors previously reviewed by Pennock, et al. When employing a neck seal, the seal must be tight enough to restrain the mouse while avoiding leak, yet loose enough to avoid constriction. As it is difficult to standardize the tightness of neck seals, this may introduce some variability in the measurements, and heighten baseline values. The basis for the large discrepancy between sRaw-RWBP and sRaw-DCP was not disclosed by this study.

Strain Specific Airway Reactivity

The C57 mice exhibited significantly higher breathing frequency, minute volume, and peak flows than A/J or BALBc mice, and higher tidal volumes than A/J mice. The C57 strain was previously found to have higher minute ventilation than BALBc (Flandre, et al.), and this was thought to reflect their greater basal metabolism, body temperature, and lower hematocrit. Differences in ventilatory properties may have contributed to differences in methacholine delivery or response to methacholine.

Airway reactivity in the 3 strains of mice differed significantly (Table 3). Concerning the gold standard (FOT), methacholine reactivity paralleled past data on this subject using BALBc mice (Wagers, S., L. Lundblad, et al. (2002). “Nonlinearity of respiratory mechanics during bronchoconstriction in mice with airway inflammation.” J Appl Physiol 92(5): 1802-7., incorporated herein by reference). The descending order of airway reactivity differed between RWBP (AJ>BALBc>C57) and FOT (AJ>BALBc=C57) largely due to relatively lower reactivity of conscious C57 mice. The relative airway reactivity found in this study using RWBP (AJ>BALBc>C57) mirrored past studies that have employed invasive technologies in 2 or 3 of the same strains (De Sanctis, G. T., J. B. Singer, et al. (1999). “Quantitative trait locus mapping of airway responsiveness to chromosomes 6 and 7 in inbred mice.” Am J Physiol 277(6 Pt 1): L1118-23., incorporated herein by reference, Duguet, et al., and Takeda, K., A. Haczku, et al. (2001). “Strain dependence of airway hyperresponsiveness reflects differences in eosinophil localization in the lung.” Am J Physiol Lung Cell Mol Physiol 281(2): L394-402., incorporated herein by reference) as well as published data on airway reactivity (using UWBP) from the vendor for C57 and A/J mice. One study that compared double chamber (sRaw) to single chamber (Penh) measures of airway reactivity disclosed rank orders BALBc>AJ>C57 for DCP, and AJ>BALBc>C57 as in our study for UWBP (DeLorme, et al.). We do not have an explanation for the differences between conscious and invasive measures of airway reactivity. It is possible that conscious measurements of airway reactivity in C57 mice, which are typically hypo-responsive, were influenced by their uniquely exaggerated minute ventilation, or another conscious factor that altered drug delivery. The endpoint used to define airway reactivity in this study (ED175) was not a maximal response, so we performed additional studies comparing the three methods (RWBP, DCP, and FOT) in BALBc. The three methods applied to BALBc mice produced equivalent ED175. However, the maximal percentage changes in sRaw-RWBP and sRaw-DCP) were both significantly greater than Raw-FOT. This would imply that airway responsiveness differed between conscious and invasive techniques. This study did not disclose the mechanisms by which these results differed. However, one could speculate that nasal delivery of methacholine resulted in change in upper airway aperture (e.g. glottic resistance) or lung hyperinflation that was absent during invasive challenges.

The effect of OVA exposure by aerosol in sensitized mice did not evoke a change in baseline at the time period studied (48 hrs). Similarly, no effect was seen in baseline airway or tissue mechanics in a past study using a similar protocol comparing OVA−/OVA− to OVA+/OVA+ BALBc mice (Tomioka, et al.). Using RWBP there was a significant decrease in ED175 (P=0.037). The magnitude of this change was comparable to past studies using short-term exposure periods (Glaab, Daser, et al. and Chang, Y. S., Y. K. Kim, et al. (2005). “Comparison of asthma phenotypes using different sensitizing protocols in mice.” Korean J Intern Med 20(2): 152-8., incorporated herein by reference). In sum, RWBP was found to be sufficiently sensitive to track traditional allergen-induced airway hyper-reactivity.

### Conclusions

This study demonstrates for the first time the measurement of specific airway resistance (sRaw) using restrained whole body plethysmography (RWBP) in conscious mice. The non-invasive method of RWBP permitted highly reproducible measurements of sRaw, without acclimation to the instrument. Values for sRaw were roughly comparable to those derived from the invasive forced oscillation technique. Strain specific and allergen-induced effects on airway reactivity were demonstrated using RWBP. Relative strain-related airway reactivity was different between conscious methods (RWBP) and FOT. The technique of RWBP holds promise for serial measurements of sRaw and challenge testing in conscious mice.

The mouse is the most extensively studied animal species in respiratory research, yet the technologies available to assess airway function in conscious mice are not universally accepted. This study hypothesized that whole body plethsymography employing non-invasive restraint (RWBP) could be used to quantify specific airway resistance (sRaw-RWBP) and airway reactivity in conscious mice. Methacholine responses were compared using sRaw-RWBP versus airway resistance forced oscillation technique (Raw-FOT) in groups of C57, A/J, and BALBc mice. SRaw-RWBP was also compared to sRaw derived from double chamber plethysmography (sRaw-DCP) in BALBc. Finally, airway reactivity following allergen challenge in BALBc was measured using RWBP. SRaw-RWBP in C57, A/J, and BALBc mice was 0.51±0.03, 0.68±0.03, and 0.63±0.05 cm*second, respectively. The intra- and inter-animal coefficients of variations were similar between sRaw-RWBP (6.8 and 20.1%) and Raw-FOT (3.4 and 20.1%, respectively). In order of airway reactivity employing sRaw-RWBP was AJ>BALBc>C57 and for Raw-FOT was AJ>BALBc=C57. Thee was no difference between the reactivity assessed by RWBP vs. DCP; however baseline sRaw-RWBP was significantly lower than sRaw-DCP. Maximum responses to methacholine using conscious methods (both RWBP and DCP) were significantly higher than FOT. Allergen challenge caused a significant increase in methacholine reactivity using RWBP. In conclusion, the technique of RWBP was rapid, reproducible, and easy to perform. Values of sRaw-RWBP were similar to those derived by invasive methods. Strain-specific airway reactivity differed between conscious and invasive (FOT) measures, supporting the notion that conscious factors modulate the responses to cholinergic agents.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An apparatus for monitoring respiratory function in an animal, comprising:
a restraint chamber for restraining the animal, the restraint chamber comprising a nose cone at a first end for receiving the head of the animal and a tube having a plurality of holes at a second end wherein the nose cone and the tube are coupled such that the restraint chamber is non-constraining;
an outer chamber in which the restraint chamber is positioned;
a first sensor mounted to a proximal end of the nose cone of the restraint chamber for detecting a first parameter related to respiratory function in the animal; and
a second sensor coupled to the outer chamber for detecting a second parameter related to respiratory function in the animal.

2. The apparatus of claim 1, wherein the tube having the plurality of holes comprises holes overlying a chest and abdomen of the animal.

3. The apparatus of claim 1, wherein the restraint chamber is coupled to the first sensor by a docking station.

4. The apparatus of claim 3, wherein the docking station comprises a nose cone receptor for receiving the nose cone of the restraint chamber.

5. The apparatus of claim 4, wherein the nose cone receptor and nose cone provide visualization of a seal of the nose.

6. The apparatus of claim 3, wherein the docking station comprises a rotating stopcock.

7. The apparatus of claim 6, wherein the stopcock assembly permits each of nasal flow measurement, aerosol delivery, and leak testing of a seal of the nose cone, each from the outside of the box.

8. The apparatus of claim 3, wherein the docking station comprises a pneumotachograph.

9. The apparatus of claim 1, wherein the apparatus further comprises a platform having a track, and the restraint chamber further comprises a guide that moves along the track such that the track facilitates the movement of the restraint chamber.

10. The apparatus of claim 1, wherein the first and second parameters are related to resistance of an airway of the animal.

11. The apparatus of claim 1, wherein the first parameter is related to air flow at the nose of the animal.

12. The apparatus of claim 1, wherein the second parameter is related to a pressure change in the chamber.

13. The apparatus of claim 1, wherein the second parameter is related to a pressure change in the animal.

14. The apparatus of claim 1, wherein the second parameter is related to volume of the body of the animal.

15. The apparatus of claim 1, wherein the first and second parameters are combined to monitor respiratory function in the animal.

16. The apparatus of claim 1, wherein, in a first mode, the outer chamber is substantially sealed such that the apparatus measures pressure, and in a second mode, the outer chamber has a leak such that the apparatus is used to measure flow.

17. An apparatus for monitoring respiratory function in an animal, comprising:
a restraint chamber for restraining the animal, the restraint chamber comprising a nose cone at a first end for receiving the head of the animal and a tube having a plurality of holes at a second end;
a docking station for interlocking with the restraint chamber, the docking station comprising a first sensor for detecting a first parameter related to respiratory function in the animal;
an outer chamber in which the restraint chamber and the docking station are positioned; and
a second sensor coupled to the outer chamber for detecting a second parameter related to respiratory function in the animal.

18. The apparatus of claim 17, wherein the tube having the plurality of holes comprises holes overlying a chest and abdomen of the animal.

19. The apparatus of claim 17, wherein the docking station comprises a nose cone receptor for receiving the nose cone of the restraint chamber.

20. The apparatus of claim 19, wherein the nose cone receptor and nose cone provide visualization of a seal of the nose.

21. The apparatus of claim 17, wherein the docking station comprises a rotating stopcock.

22. The apparatus of claim 21, wherein the stopcock assembly permits each of nasal flow measurement, aerosol delivery, and leak testing of the nose cone, each from the outside of the box.

23. The apparatus of claim 17, wherein the docking station comprises a pneumotachograph.

24. The apparatus of claim 17, wherein the apparatus further comprises a platform having a track, and the restraint chamber further comprises a guide that moves along the track such that the track facilitates the movement of the restraint chamber.

25. The apparatus of claim 17, wherein the first and second parameters are related to resistance of an airway of the animal.

26. The apparatus of claim 17, wherein the first parameter is related to air flow at the nose of the animal.

27. The apparatus of claim 17, wherein the second parameter is related to a pressure change in the chamber.

28. The apparatus of claim 17 wherein the second parameter is related to a pressure change in the animal.

29. The apparatus of claim 17, wherein the second parameter is related to volume of the body of the animal.

30. The apparatus of claim 17, wherein the first and second parameters are combined to monitor respiratory function in the animal.

31. The apparatus of claim 17, wherein, in a first mode, the outer chamber is substantially sealed such that the apparatus measures pressure, and in a second mode, the outer chamber has a leak such that the apparatus is used to measure flow.

32. An apparatus for monitoring respiratory function in an animal, comprising:
a restraint chamber for restraining the animal, the restraint chamber comprising a nose cone at a first end for receiving the head of the animal and a tube having a plurality of holes at a second end, the tube having a protrusion, the protrusion having a sliding track, wherein the tube slides with respect to the nose cone along the sliding track of the protrusion coupling the tube to the nose cone;
an outer chamber in which the restraint chamber is positioned;
a first sensor mounted to a proximal end of the nose cone of the restraint chamber for detecting a first parameter related to respiratory function in the animal; and
a second sensor coupled to the outer chamber for detecting a second parameter related to respiratory function in the animal.

33. The apparatus of claim 32, wherein the tube having the plurality of holes comprises holes overlying a chest and abdomen of the animal.

34. The apparatus of claim 32, wherein the restraint chamber is coupled to the first sensor by a docking station.

35. The apparatus of claim 34, wherein the docking station comprises a nose cone receptor for receiving the nose cone of the restraint chamber.

36. The apparatus of claim 35, wherein the nose cone receptor and nose cone provide visualization of a seal of the nose.

37. The apparatus of claim 34, wherein the docking station comprises a rotating stopcock.

38. The apparatus of claim 37, wherein the stopcock assembly permits each of nasal flow measurement, aerosol delivery, and leak testing of the nose cone, each from the outside of the box.

39. The apparatus of claim 34, wherein the docking station comprises a pneumotachograph.

40. The apparatus of claim 32, wherein the apparatus further comprises a platform having a track, and the restraint chamber further comprises a guide that moves along the track such that the track facilitates the movement of the restraint chamber.

41. The apparatus of claim 32, wherein the first and second parameters are related to resistance of an airway of the animal.

42. The apparatus of claim 32, wherein the first parameter is related to air flow at the nose of the animal.

43. The apparatus of claim 32, wherein the second parameter is related to a pressure change in the chamber.

44. The apparatus of claim 32, wherein the second parameter is related to a pressure change in the animal.

45. The apparatus of claim 32, wherein the second parameter is related to volume of the body of the animal.

46. The apparatus of claim 32, wherein the first and second parameters are combined to monitor respiratory function in the animal.

47. The apparatus of claim 32, wherein, in a first mode, the outer chamber is substantially sealed such that the apparatus measures pressure, and in a second mode, the outer chamber has a leak such that the apparatus is used to measure flow.

48. An apparatus for monitoring respiratory function in an animal, comprising:
a restraint chamber for restraining the animal, the restraint chamber comprising a nose cone at a first end for receiving the head of the animal and a tube having a plurality of holes and a protrusion having a sliding track at a second end, wherein the nose cone slides with respect to the tube along the sliding track of the protrusion coupling the nose cone to the tube;
an outer chamber in which the restraint chamber and the platform are positioned;
a first sensor coupled to a proximal end of the nose cone of the restraint chamber for detecting a first parameter related to respiratory function in the animal; and
a second sensor coupled to the outer chamber for detecting a second parameter related to respiratory function in the animal.

49. The apparatus of claim 48, wherein the tube having the plurality of holes comprises holes overlying a chest and abdomen of the animal.

50. The apparatus of claim 48, wherein the restraint chamber is coupled to the first sensor by a docking station.

51. The apparatus of claim 50, wherein the docking station comprises a nose cone receptor for receiving the nose cone of the restraint chamber.

52. The apparatus of claim 51, wherein the nose cone receptor and nose cone provide visualization of a seal of the nose.

53. The apparatus of claim 50, wherein the docking station comprises a rotating stopcock.

54. The apparatus of claim 53, wherein the stopcock assembly permits each of nasal flow measurement, aerosol delivery, and leak testing of the nose cone, each from the outside of the box.

55. The apparatus of claim 50, wherein the docking station comprises a pneumotachograph.

56. The apparatus of claim 48, wherein the apparatus further comprises a platform having a track, and the restraint chamber further comprises a guide that moves along the track such that the track facilitates the movement of the restraint chamber.

57. The apparatus of claim 48, wherein the first and second parameters are related to resistance of an airway of the animal.

58. The apparatus of claim 48, wherein the first parameter is related to air flow at the nose of the animal.

59. The apparatus of claim 48, wherein the second parameter is related to a pressure change in the chamber.

60. The apparatus of claim 48, wherein the second parameter is related to a pressure change in the animal.

61. The apparatus of claim 48, wherein the second parameter is related to volume of the body of the animal.

62. The apparatus of claim 48, wherein the first and second parameters are combined to monitor respiratory function in the animal.

63. The apparatus of claim 48, wherein, in a first mode, the outer chamber is substantially sealed such that the apparatus measures pressure, and in a second mode, the outer chamber has a leak such that the apparatus is used to measure flow.

64. An apparatus for monitoring respiratory function in an animal, comprising:
a restraint chamber for restraining the animal; and
an outer chamber in which the restraint chamber is positioned;
wherein, in a first mode, the outer chamber is substantially sealed such that the apparatus measures pressure, and in a second mode, the outer chamber has a leak such that the apparatus is used to measure flow.

65. The apparatus of claim 64, wherein the restraint chamber comprises a nose cone at a first end for receiving the head of the animal and a tube having a plurality of holes at a second end.

66. The apparatus of claim 65, wherein the tube having the plurality of holes comprises holes overlying a chest and abdomen of the animal.

67. The apparatus of claim 65, the apparatus further comprises a first sensor mounted to a proximal end of the nose cone of the restraint chamber for detecting a first parameter related to respiratory function in the animal.

68. The apparatus of claim 67, wherein the apparatus further comprises a second sensor coupled to the outer chamber for detecting a second parameter related to respiratory function in the animal.

69. The apparatus of claim 67, wherein the restraint chamber is coupled to the first sensor by a docking station.

70. The apparatus of claim 69, wherein the docking station comprises a nose cone receptor for receiving the nose cone of the restraint chamber.

71. The apparatus of claim 70, wherein the nose cone receptor and nose cone provide visualization of a seal of the nose.

72. The apparatus of claim 69, wherein the docking station comprises a rotating stopcock.

73. The apparatus of claim 72, wherein the stopcock assembly permits each of nasal flow measurement, aerosol delivery, and leak testing of the nose cone, each from the outside of the box.

74. The apparatus of claim 69, wherein the docking station comprises a pneumotachograph.

75. The apparatus of claim 64, wherein the apparatus further comprises a platform having a track, and the restraint chamber further comprises a guide that moves along the track such that the track facilitates the movement of the restraint chamber.

76. The apparatus of claim 68, wherein the first and second parameters are related to resistance of an airway of the animal.

77. The apparatus of claim 67, wherein the first parameter is related to air flow at the nose of the animal.

78. The apparatus of claim 68, wherein the second parameter is related to a pressure change in the chamber.

79. The apparatus of claim 68, wherein the second parameter is related to a pressure change in the animal.

80. The apparatus of claim 68, wherein the second parameter is related to volume of the body of the animal.

81. The apparatus of claim 68, wherein the first and second parameters are combined to monitor respiratory function in the animal.
